(19) United States
(12) Patent Application Publication
(10) Pub. No.: US 2026/0222686 A1
(43) Pub. Date: Jul. 30, 2026

(54) IMAGE PROCESSING DEVICE, IMAGE PROCESSING METHOD, AND STORAGE MEDIUM

(71) Applicant: Sony Semiconductor Solutions Corporation, Kanagawa (JP)

(72) Inventor: Hitoshi OZAWA, Kanagawa (JP)

(73) Assignee: Sony Semiconductor Solutions Corporation, Kanagawa (JP)

(21) Appl. No.: 19/141,352

(22) PCT Filed: Dec. 18, 2023
(86) PCT No.: PCT/JP2023/045285

§ 371 Date: Jun. 20, 2025

(30) Foreign Application Priority Data
Dec. 27, 2022 (JP) 2022-210435

(51) Int. Cl. H04N 23/68

(52) U.S. Cl. CPC H04N 23/683; H04N 23/6811; H04N 23/6812

(57) ABSTRACT

An image processing configuration that determines whether a processing overrun has occurred following generation of a first clipped image based on a first frame of image data captured by an image sensor; acquires a second frame of image data captured by the image sensor after the first frame of image data has been captured; generates a second clipped image based on the second frame of image data and second movement data corresponding to movement of the image sensor while capturing the second frame of image data in a case it is determined that the processing overrun has not occurred; generates the second clipped image based on the second frame of image data and first movement data corresponding to movement of the image sensor while capturing a previous frame of image data in a case it is determined that the processing overrun has occurred; and outputs the second clipped image.

### TECHNICAL FIELD

The present technology relates to an image processing device, an image processing method, and a storage medium, and more particularly to a technology relating to electronic image stabilization.

### BACKGROUND ART

For electronic image stabilization, a technique is known that cancels blurring of a subject in an image to be output (output image) by performing a stabilization process that changes the clipping position in the captured image capturing a wider area than an image to be output (for example, PTL 1 below).

### CITATION LIST

### Patent Literature

PTL 1: JP 2020-107036A

### SUMMARY

### Technical Problem

When the amount of blurring is large, the computation amount of the stabilization process increases, and the calculation of the clipping position may fail to be completed by a predetermined time (hereinafter referred to as “a processing overrun”). In particular, when the calculated clipping position is outside the area of the captured image, processing for readjusting the clipping position within the area of the captured image is performed, and a processing overrun tends to occur.

When a processing overrun occurs, the output of the output image is interrupted or stopped, or a meaningless mute image that is irrelevant to the captured image is output.

However, this operation is not considered desirable by the photographer.

In view of the foregoing circumstances, it is an object of the present technology to output an image that is appropriate to some extent, even when a processing overrun occurs in which a stabilization process is not completed in time.

According to a first exemplary configuration, the disclosure is directed to an image processing system comprising: circuitry configured to determine whether a processing overrun has occurred following generation of a first clipped image based on a first frame of image data captured by an image sensor; acquire a second frame of image data captured by the image sensor after the first frame of image data has been captured; generate a second clipped image based on the second frame of image data and second movement data corresponding to movement of the image sensor while capturing the second frame of image data in a case it is determined that the processing overrun has not occurred; generate the second clipped image based on the second frame of image data and first movement data corresponding to movement of the image sensor while capturing a previous frame of image data in a case it is determined that the processing overrun has occurred; and outputting the second clipped image.

According to another exemplary configuration, the disclosure is directed to an image processing method comprising: generating a first clipped image based on a first frame of image data captured by an image sensor and first movement data corresponding to movement of the image sensor while the capturing the first frame of image data; outputting the first clipped image; acquiring a second frame of image data and movement data corresponding to movement of the image sensor whole capturing the second frame of image data; determining that a processing overrun has occurred as a result of generating the first clipped image; generating a second clipped image based on movement data corresponding to a previously acquired frame image data in response to determining that the processing overrun has occurred; and outputting the second clipped image

According to another exemplary configuration, the disclosure is directed to one or more non-transitory computer readable media including computer program instructions, which when executed by circuitry, cause the circuitry to: generate a first clipped image based on a first frame of image data captured by an image sensor and first movement data corresponding to movement of the image sensor while the capturing the first frame of image data; output the first clipped image; acquire a second frame of image data and movement data corresponding to movement of the image sensor whole capturing the second frame of image data; determine that a processing overrun has occurred as a result of generating the first clipped image; generate a second clipped image based on movement data corresponding to a previously acquired frame image data in response to determining that the processing overrun has occurred; and output the second clipped image.

According to the configurations disclosed below, the image processing system, method, computer-readable medium results in outputting an image that is appropriate to some extent, even when a processing overrun occurs in which a stabilization process is not completed in time.

### BRIEF DESCRIPTION OF DRAWINGS

FIG. 1 is a block diagram showing a configuration example of a camera device according to a first embodiment of the present technology.

FIG. 2 is a block diagram showing a configuration example of an image processing device according to the first embodiment.

FIG. 3 is an explanatory diagram of electronic image stabilization.

FIG. 4 is a diagram illustrating a countermeasure process for an occurrence of a processing overrun in the first embodiment.

FIG. 5 is a flowchart of a process performed by the image processing device according to the first embodiment.

FIG. 6 is a block diagram showing a configuration example of an image processing device according to a second embodiment.

FIG. 7 is a diagram illustrating a countermeasure process for an occurrence of a processing overrun in the second embodiment.

FIG. 8 is a flowchart of a process performed by the image processing device according to the second embodiment.

FIG. 9 is a diagram illustrating a countermeasure process for an occurrence of a processing overrun in a third embodiment.

FIG. 10 is a flowchart of a process performed by an image processing device according to the third embodiment.

FIG. 11 is a flowchart of a process performed by the image processing device according to the third embodiment.

FIG. 12 is a flowchart of a process performed by the image processing device according to the third embodiment.

FIG. 13 is a flowchart of a process performed by the image processing device according to the third embodiment.

FIG. 14 is a diagram illustrating a countermeasure process for an occurrence of a processing overrun in a fourth embodiment.

FIG. 15 is a flowchart of a process performed by the image processing device according to the fourth embodiment.

FIG. 16 is a block diagram showing a configuration example of an image processing device according to a fifth embodiment.

FIG. 17 is a diagram illustrating a countermeasure process for an occurrence of a processing overrun in the fifth embodiment.

FIG. 18 is a flowchart of a process performed by the image processing device according to the fifth embodiment.

FIG. 19 is a diagram illustrating a countermeasure process for an occurrence of a processing overrun in a sixth embodiment.

FIG. 20 is a flowchart of a process performed by the image processing device according to the sixth embodiment.

FIG. 21 is a block diagram showing a configuration example of an image processing device according to a first modification.

FIG. 22 is a diagram illustrating a countermeasure process for an occurrence of a processing overrun in a second modification.

FIG. 23 is a block diagram showing a configuration example of a camera device according to a third modification.

FIG. 24 is a diagram showing the sizes and the positional relationship of the images in another example.

FIG. 25 is a diagram showing the relationship of timing relating to communication in another example.

### DESCRIPTION OF EMBODIMENTS

Referring to the accompanying drawings, embodiments according to the present technology are described below in the following order.
<1. Overall Configuration of Camera Device>
<2. Configuration of Image Processing Device>
<3. Stabilization Process>
<4. Countermeasure Process for Occurrence of Processing Overrun>
<5. Flowchart>
<6. Second Embodiment>
<7. Third Embodiment>
<8. Fourth Embodiment>
<9. Fifth Embodiment>
<10. Sixth Embodiment>
<11. Modifications>
<11-1. First Modification>
<11-2. Second Modification>
<11-3. Third Modification>
<12. Others>
<13. Summary>
<14. Present Technology>

### 1. Overall Configuration of Camera Device

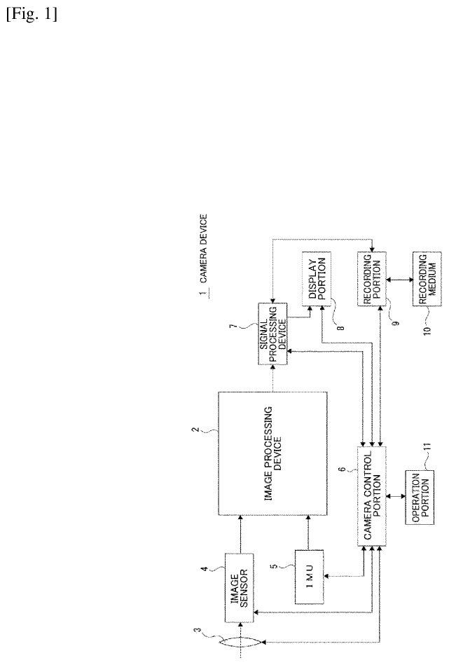

Referring to FIG. 1, a first embodiment of the configuration of a camera device 1 including an image processing device of the present technology is now described. However, the present technology is not limited to this, and can be applied to an image processing device that is separate from a camera device.

Also, although not particularly mentioned in the following description, the camera device 1 can be applied to various camera devices, such as a still camera, a video camera, or a smartphone or feature phone having a camera function.

Additionally, the lens device provided in the camera device 1 may be incorporated in the main body of the camera device 1, may be of a collapsible type in which the lens barrel is extended or retracted relative to the device main body, or may be of an inter-changeable type in which the lens barrel is separate from the main body.

The camera device 1 is configured to include an image processing device 2, an optical lens system 3, an image sensor 4, an inertial measurement unit (IMU) 5, a camera control portion 6, a signal processing portion 7, a display portion 8, a recording portion 9, a recording medium 10, an operation portion 11, a power supply portion (not shown), and the like.

The image processing device 2 is composed of a microprocessor such as a digital signal processor (DSP) that is specialized for digital signal processing, a microcomputer, and the like, and performs a stabilization process for electronic image stabilization, which electrically corrects blurring of a subject in a captured image. The image processing device 2 outputs, as an output image Oi, an image obtained by applying a stabilization process to a captured image to the signal processing portion 7 in the subsequent stage.

The image sensor 4, which receives light from a subject that is incident through the optical lens system 3 and performs photoelectric conversion, inputs a captured image signal to the image processing device 2. In the following description, the captured image signal input from the image sensor 4 to the image processing device 2 is simply referred to as a “captured image” or “frame image Fi”.

The optical lens system 3 is configured to include various lenses, such as an incident end lens, a zoom lens, a focus lens, and a condenser lens, an aperture mechanism, which controls exposure by adjusting the aperture amount of the lens and the iris such that sensing is performed while the signal charge is within the dynamic range and not saturated, and a shutter unit, such as a focal plane shutter. It should be noted that the configurations of the optical lens system 3 are merely an example, it may have other configurations, or may not include some configurations.

For example, the image sensor 4 is configured as a charge coupled device (CCD) sensor or a complementary metal oxide semiconductor (CMOS) sensor, and includes a light receiving portion with a two-dimensional array of pixels, which receives incident light from the subject and performs photoelectric conversion.

The light receiving portion outputs a pixel signal that is a signal obtained by photoelectric conversion and is a signal corresponding to the amount of incident light received by the pixel. A pixel signal output from the light receiving portion is converted into a digital signal by an analog to digital converter (ADC) and supplied to the image processing device 2 and the camera control portion 6 as a captured image (frame image Fi).

Acceleration information and angular velocity information on the camera device 1 detected by the IMU 5 are also input to the image processing device 2.

The IMU 5 generates acceleration information and angular velocity information corresponding to the movement and orientation of the camera device 1 at a predetermined sampling rate and supplies them to the image processing device 2. In the following description, the acceleration information and angular velocity information output from the IMU 5 are referred to as “IMU data”.

Here, since the light receiving portion of the image sensor 4 performs imaging operation by the rolling shutter method, the exposure timing is slightly different for each line of the light receiving portion. Also, the IMU 5 intermittently outputs IMU data at intervals shorter than the exposure time for one predetermined frame image Fi.

Accordingly, the IMU data output at a certain output timing is associated with the exposure timing of a certain line in the frame image Fi.

To associate the IMU data with the line numbers of the frame images Fi, the IMU data output from the IMU 5 may be supplied to the image processing device 2 after being input to the image sensor 4 once.

In this manner, each IMU data piece is associated with a line number of the frame image Fi, allowing for the synchronization between the IMU data and frame image Fi.

As described above, the frame image Fi and IMU data are input to the image processing device 2. A specific configuration of the image processing device 2 will be described below.

The camera control portion 6 includes a microcomputer having a central processing unit (CPU), read only memory (ROM), random access memory (RAM), and the like. The CPU reads a program stored in the ROM or other predetermined storage device into the RAM and executes it to perform overall control of the camera device 1.

Based on the operation signal supplied from the operation portion 11 in response to an operation of the photographer, the camera control portion 6 enables an image capturing operation by the optical lens system 3 and the image sensor 4.

Additionally, the camera control portion 6 issues drive instructions to the optical lens system 3 to drive various lenses, optical components, and the like. This allows the photographer to bring the camera device 1 into a desired photographing state.

Specifically, the camera control portion 6 performs, for example, control of the shutter speed, control of the zoom state, or switching of various shooting modes according to an operation of the photographer. The various shooting modes include a still image shooting mode, a moving image shooting mode, and a continuous shooting mode for continuously capturing still images, for example.

The camera control portion 6 also performs a recording operation according to an operation of the photographer and a playback operation of the recorded image file.

The camera control portion 6 performs user interface control for enabling the photographer to operate these functions. The user interface control performs a process of detecting an operation on the operation portion 11 such as an operator provided in the camera device 1. When the display portion 8 provided in the camera device 1 uses a touch panel system, the camera control portion 6 performs a process of detecting an operation on the display portion 8.

The camera control portion 6 also controls various lenses of the optical lens system 3 via a driver portion (not shown). The driver portion is provided in the camera device 1 as a motor driver for a zoom lens driving motor, a motor driver for a focus lens driving motor, and an aperture mechanism driver for a motor for driving the aperture mechanism, for example. Each driver supplies a drive current to the corresponding drive motor according to an instruction from the camera control portion 6.

With such a configuration, the camera control portion 6 performs a process of specifying an aperture value to secure the necessary light amount for auto focus (AF) control, and instructs an operation of the aperture mechanism according to the aperture value, for example.

The signal processing portion 7 is composed of a microprocessor specialized for digital signal processing, such as a DSP, or a microcomputer, for example.

The signal processing portion 7 includes portions for performing various types of signal processing on the image data as an output image Oi supplied from the image processing device 2.

Specifically, demosaicing, correction processing between R, G, and B color channels, white balance correction, aberration correction, shading correction, and the like are performed.

The signal processing portion 7 also performs a YC generation process for generating (separating) a brightness (Y) signal and color (C) signal from R, G, and B image data, a process of adjusting brightness and color, knee correction, and gamma correction, for example.

Furthermore, the signal processing portion 7 performs conversion into a final output format by performing a resolution conversion process, a codec process for encoding for recording and communication, and the like. The image data converted into the final output format is stored in the recording portion 9 or a memory (not shown), for example. Additionally, the image data that is subjected to various types of processing by the signal processing portion 7 is output to the display portion 8, so that images are displayed on the display portion 8 provided on the back side of the camera housing, the display portion 8 provided in the electronic view finder (EVF), and the like. Furthermore, the image data from the signal processing portion 7 may be output from an external output terminal and thus displayed on a device such as a monitor provided outside the camera device 1.

The display portion 8 is implemented as monitors provided in portions of the camera device 1. Specifically, as described above, the monitor provided on the back side of the camera housing, the monitor provided in the EVF, and the like serve as the display portion 8.

The display portion 8 performs processes for performing various types of display for the photographer. The display portion 8 performs the process of displaying the image data that is input from the signal processing portion 7 and converted to an appropriate resolution. As a result, what is referred to as a through-the-lens image is displayed during release standby.

The display portion 8 also allows for display on the screen as a graphical user interface (GUI), such as various operation menus, icons, messages, and the like, on the basis of instructions from the camera control portion 6.

Also, the display portion 8 can display a reproduced image of the image data read from the recording medium 10 under the control of the recording portion 9.

The recording portion 9 performs, for the various types of recording media 10 set in the camera device 1, a process of storing image files of still image data, moving image data, and the like (content file), image file attribute information, thumbnail images, and the like and a reading process.

Image files may be stored in various formats such as Joint Photographic Experts Group (JPEG), Tagged Image File Format (TIFF), and Graphics Interchange Format (GIF).

The recording medium 10 is composed of a non-volatile memory, and various modes are conceivable. For example, the recording medium 10 may be configured as a flash memory built in the camera device 1, or may be configured as a memory card (for example, a portable flash memory) that can be attached to and detached from the camera device 1. Also, the recording medium 10 may be implemented as a hard disk drive (HDD), a solid state drive (SSD), or the like as a form embedded in the camera device 1.

The operation portion 11 is configured to include, in addition to the shutter button, the zoom button, and the like, the display portion 8 that uses the touch panel system as described above. The operation portion 11 outputs operation information to the camera control portion 6 according to the operation of the photographer.

It should be noted that the operation portion 11 may function as a reception portion for an external operating device, such as a remote controller that is separate from the camera device 1. Examples of external operating devices include smartphones, tablets, Bluetooth (registered trademark) remote controllers, wired remote controllers, and wireless operating devices for focus operation.

A power supply portion (not shown) supplies power supplied from a secondary battery, such as a NiCd battery, NiMH battery, or Li battery, to each portion of the camera device 1 including the camera control portion 6. The power supply portion can also be configured to be capable of receiving power supply from a commercial AC power supply via an AC adapter or the like.

It should be noted that the camera device 1 may be configured to include, as appropriate, a communication portion for performing data communication and network communication with external devices, a light emitting portion for performing flash photography, and the like, in addition to the above.

### 2. Configuration of Image Processing Device

The image processing device 2 performs a stabilization process on a frame image Fi supplied from the image sensor 4, as described above.

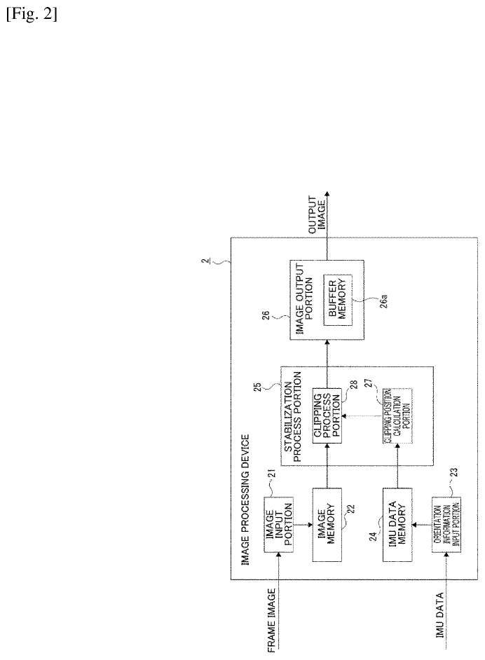

FIG. 2 shows a configuration example of the image processing device 2 according to the first embodiment.

The image processing device 2 is configured to include an image input portion 21, an image memory 22, an orientation information input portion 23, an IMU data memory 24, a stabilization process portion 25, and an image output portion 26, for example.

A frame image Fi output from the image sensor 4 is input to the image input portion 21. The frame image Fi input to the image input portion 21 is output to the image memory 22. The image memory 22 may be composed of a volatile memory or the like, and supplies the frame image Fi to the stabilization process portion 25 after temporarily storing the frame image Fi.

The IMU data (orientation information) output from the IMU 5 is input to the orientation information input portion 23. The IMU data input to the orientation information input portion 23 is output to the IMU data memory 24. The IMU data memory 24 may be composed of a volatile memory or the like, and supplies the IMU data to the stabilization process portion 25 after temporarily storing the IMU data.

The stabilization process portion 25 includes a clipping position calculation portion 27, which calculates clipping positions so as to cancel the movement of the subject between frame images Fi within the angle of view of the image sensor 4 on the basis of the supplied IMU data.

The stabilization process portion 25 also includes a clipping process portion 28 that clips a part of the frame image Fi on the basis of the clipping position calculated by the clipping position calculation portion 27.

As a result, the position of the subject in the clipped image clipped from the frame image Fi is stabilized, achieving electronic image stabilization.

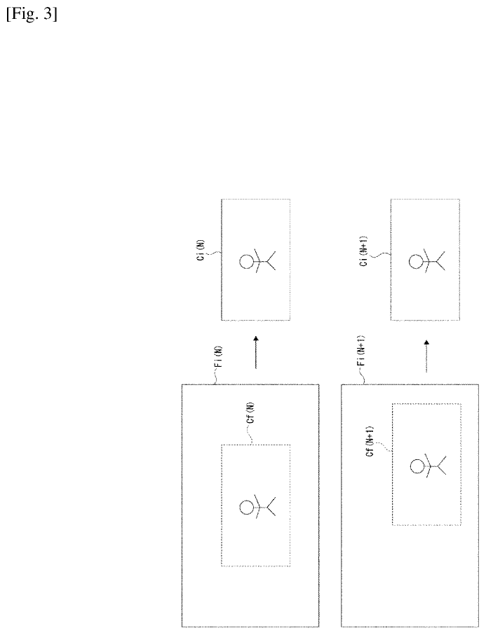

FIG. 3 shows how a change in position of a subject is canceled using a clipping position.

In the following description, the Nth frame image Fi that serves as a reference is referred to as a frame image Fi(N). That is, the frame image immediately before the reference frame image Fi(N) is referred to as the frame image Fi(N?1), and the frame image immediately after is referred to as the frame image Fi(N+1).

Also, the clipping frame Cf based on the clipping position in the reference frame image Fi(N), specifically, the clipping frame Cf set on the basis of the IMU data detected during the exposure period of the frame image Fi(N) is referred to as the clipping frame Cf(N). The clipped image Ci that is a partial image clipped from the frame image Fi(N) is referred to as the clipped image Ci(N).

When the position of the subject changes in successive frame images Fi(N) and Fi(N+1), the clipping frames Cf(N) and Cf(N+1) are set at different positions so as to follow the position of the subject.

As a result, there is no significant change in the position of the subject in the clipped images Ci(N) and Ci(N+1).

That is, when the position and orientation of the camera device 1 change and blurring occurs, the amount of flame-to-frame displacement of the position of the subject is reduced on the display portion 8 that displays the clipped image Ci, for example, by changing the position of the clipping frame Cf on the basis of the IMU data specifying the orientation change. This achieves electronic image stabilization.

In this manner, the stabilization process portion 25 calculates the clipping position for each frame image Fi and clips a part of the frame image Fi as a clipped image Ci, thereby achieving the stabilization process. Additionally, by changing the clipping position on the basis of the IMU data, only the movement (blurring) of the subject due to the change in the angle of view of the camera is canceled, and the movement (blurring) of the subject due to the movement of the subject itself is not caneled.

Information on the clipping position calculated by the stabilization process portion 25 is supplied to the image output portion 26.

The clipping process portion 28 inputs the clipped image Ci clipped from the frame image Fi on the basis of the clipping frame Cf to the image output portion 26 as a stabilized image Si.

The image output portion 26 is configured to include a buffer memory 26a. The stabilized image Si input to the image output portion 26 is output from the image output portion 26 after being accumulated in the buffer memory 26a until a predetermined timing.

The stabilized image Si output from the image output portion 26 is output from the image processing device 2 as an output image Oi.

### 3. Stabilization Process

In this example, the stabilization process performed by the stabilization process portion 25 is a process of setting a clipping position in a frame image Fi and clipping the frame image Fi.

The stabilization process is performed using multiple pieces of IMU data detected during a frame period for generating one frame image Fi, that is, during a frame period based on a vertical synchronization signal Vsync1.

Normally, the stabilization process is performed after multiple pieces of IMU data detected in one frame period are collected, thereby requiring a certain amount of time before a stabilized image Si is generated.

The stabilization process portion 25 in this example performs divisional stabilization processes obtained by dividing a stabilization process. For example, in divisional stabilization processes, one frame period is divided into four time slots (first time Ta1, second time Ta2, third time Ta3, and fourth time Ta4), and the calculation of the stabilization process is gradually performed using partial IMU data D, which is the IMU data detected in each time slot.

Specifically, partial IMU data D1 detected in the first time Ta1, partial IMU data D2 detected in the second time Ta2, partial IMU data D3 detected in the third time Ta3, and partial IMU data D4 detected in the fourth time Ta4 are sequentially input to the orientation information input portion 23 of the image processing device 2.

When receiving these partial IMU data D pieces via the IMU data memory 24, the clipping position calculation portion 27 performs, as the first divisional stabilization process, a part of the stabilization process using the partial IMU data D1 obtained in the first time Ta1. Similarly, in the second divisional stabilization process, a part of the stabilization process is performed using the partial IMU data D2 obtained in the second time Ta2. In the third divisional stabilization process, a part of the stabilization process is performed using the partial IMU data D3 obtained in the third time Ta3. In the fourth divisional stabilization process, a part of the stabilization process is performed using the partial IMU data D4 obtained in the fourth time Ta4.

For example, in the camera device 1 that performs imaging by the rolling shutter method, each of the partial image regions obtained by diving the frame image Fi into four in the vertical direction is associated with IMU data.

As such, the first divisional stabilization process calculates the coordinates of the position in the coordinate system of the output image Oi that corresponds to the uppermost partial image region in the frame image Fi. In other words, the divisional stabilization process is a process of calculating the points in the frame image Fi that correspond to some pixels in the output coordinate system.

Similarly, the second divisional stabilization process calculates the coordinates of the position in the coordinate system of the output image Oi that corresponds to the second partial image region from the top in the frame image Fi, the third divisional stabilization process calculates the coordinates of the position in the coordinate system of the output image Oi that corresponds to the third partial image region from the top in the frame image Fi, and the fourth divisional stabilization process calculates the coordinates of the position in the coordinate system of the output image Oi that corresponds to the lowest partial image region in the frame image Fi.

In this manner, by performing divisional stabilization processes using IMU data associated with the partial image regions and their exposure timing, it is possible to proceed with the stabilization process before all the IMU data pieces detected in one frame period are collected.

In the fourth divisional stabilization process, which is performed last in one stabilization process, when the calculated final clipping position is located outside the angle of view of the frame image Fi, correction is performed to place the clipping position within the angle of view of the frame image Fi. Thus, the fourth divisional stabilization process tends to involve a longer processing time than the other divisional stabilization processes. Another factor that the fourth divisional stabilization process involves a longer processing time than the other divisional stabilization processes is that a process of clipping the clipped image Ci from the frame image Fi according to the calculated final clipping position is performed.

It should be noted that the divisional stabilization processes other than the fourth divisional stabilization process tend to take longer processing times when the movement of the camera device 1 is large.

In the following description, a situation in which a divisional stabilization process takes too long to plot an output image Oi in time is referred to as a “processing overrun”. Countermeasures for plotting an output image Oi in time when a processing overrun occurs are now described.

In each of the following examples, a case in which the fourth divisional stabilization process is prolonged is illustrated, but the same may be performed also when another divisional stabilization process is prolonged.

### 4. Countermeasure Process for Occurrence of Processing Overrun

The countermeasure process for an occurrence of a processing overrun of the present embodiment is to temporarily avoid performing divisional stabilization processes.

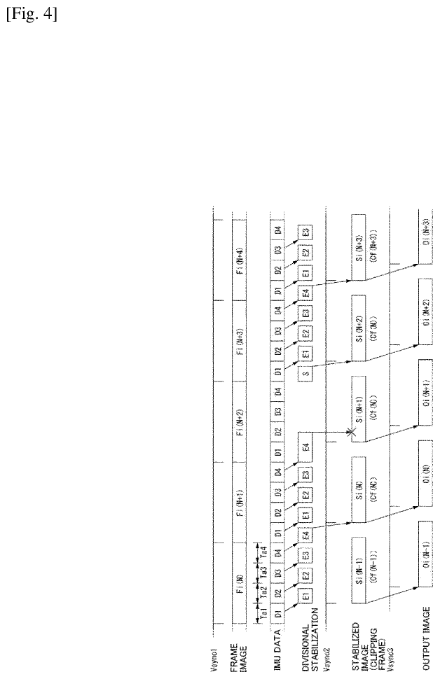

Referring to FIG. 4, the flow of process of the first embodiment is now specifically described.

Vsync1 in the figure is a signal used in the image sensor 4 for periodically outputting frame images, and is a vertical synchronization signal.

Vsync2 and Vsync3 are signals obtained by adding predetermined delays to Vsync1, which is a vertical synchronization signal, and are signals for determining the reference timing of each process. Specifically, Vsync2 is a signal slightly delayed from Vsync1, and is a signal that defines the output timing of a stabilized image Si (stabilized image in the figure). Vsync3 is a signal slightly delayed from Vsync2, and is a signal that defines the timing at which an output image Oi (output image in the figure) is output from the image processing device 2.

Also, the Nth stabilized image Si generated corresponding to the Nth frame image Fi(N) is defined as the stabilized image Si(N). Additionally, the Nth output image Oi generated corresponding to the Nth frame image Fi(N) is defined as the output image Oi(N).

Furthermore, divisional stabilization processes (divisional stabilization in the figure) are described as divisional stabilization processes E1, E2, E3, and E4. The divisional stabilization process E1 is the above-described first divisional stabilization process, the divisional stabilization process E2 is the above-described second divisional stabilization process, the divisional stabilization process E3 is the above-described third divisional stabilization process, and the divisional stabilization process E4 is the above-described fourth divisional stabilization process.

First, the divisional stabilization processes E1, E2, E3, and E4 for the Nth frame image Fi(N) are completed within a normal processing time range. Specifically, the process end timing of the divisional stabilization process E4 is before the output start timing (Vsync2) of the Nth stabilized image Si(N).

As such, the clipped image Ci(N) clipped from the frame image Fi(N) using the clipping frame Cf(N) set in the divisional stabilization process E4 is output from the stabilization process portion 25 as the stabilized image Si(N).

Then, the image processing device 2 outputs the output image Oi(N) at an appropriate timing according to Vsync3.

Next, in the divisional stabilization processes E for the (N+1)th frame image Fi(N+1), the processing time of the divisional stabilization process E4 is prolonged. Specifically, the process end timing of the divisional stabilization process E4 is after the output start timing (Vsync2) of the (N+1)th stabilized image Si(N+1). That is, a processing overrun has occurred.

In this countermeasure process, when a processing overrun in which the process end timing of the divisional stabilization process E4 fails to meet the output start timing (Vsync2) of the (N+1)th stabilized image Si(N+1) occurs, the clipping process portion 28 of the stabilization process portion 25 generates the stabilized image Si(N+1) using the frame image Fi(N+1) and the clipping position (clipping frame Cf) of the frame image Fi of a previous frame (previous frame image).

Specifically, the clipping process portion 28 uses the clipping frame Cf(N) set for the last frame image Fi(N) and the frame image Fi(N+1) to generate the stabilized image Si(N+1).

That is, the clipping process portion 28 clips the clipped image Ci(N+1) from the latest frame image Fi(N+1) using the clipping frame Cf(N) of the last frame. Then, from the stabilization process portion 25, this clipped image Ci(N+1) is output as the stabilized image Si(N+1).

Furthermore, it is assumed that the divisional stabilization processes E for the (N+2)th frame image Fi(N+2) will be tight in terms of time because the divisional stabilization processes E for the last frame image Fi(N+1) is prolonged. As such, there is a possibility that the process end timing of the divisional stabilization process E4 fails to meet the output start timing (Vsync2) of the (N+2)th stabilized image Si(N+2).

For this reason, the clipping position calculation portion 27 skips the divisional stabilization processes E for the (N+2)th frame image Fi(N+2) as indicated by “S” in FIG. 4 and supplies a signal indicating this to the clipping process portion 28 in the subsequent stage.

In response, the clipping process portion 28 clips the clipped image Ci(N+2) from the latest frame image Fi(N+2) using the clipping frame Cf(N) of the second last frame. Then, from the stabilization process portion 25, this clipped image Ci(N+2) is output as the stabilized image Si(N+2).

That is, in this countermeasure process, for the pertinent frame for which a processing overrun has occurred and the following frame, clipped images Ci are generated with the clipping frame Cf fixed. At this time, as the frame image Fi from which clipping is performed, which is the frame image Fi subjected to a clipping process, the latest frame image Fi is always used.

Also, as the clipping position and clipping frame Cf, those that are calculated for the last frame image Fi for which the processing time of the stabilization process is less than or equal to a predetermined time, that is, the last frame image Fi for which a processing overrun did not occur, are used.

As a result, although the clipping frame Cf is not updated for two frames, considering that the shake of the camera device 1 during only two frames is assumed to be small, the image processing device 2 can output a meaningful output image Oi in which the stabilization process is applied as much as possible.

### 5. Flowchart

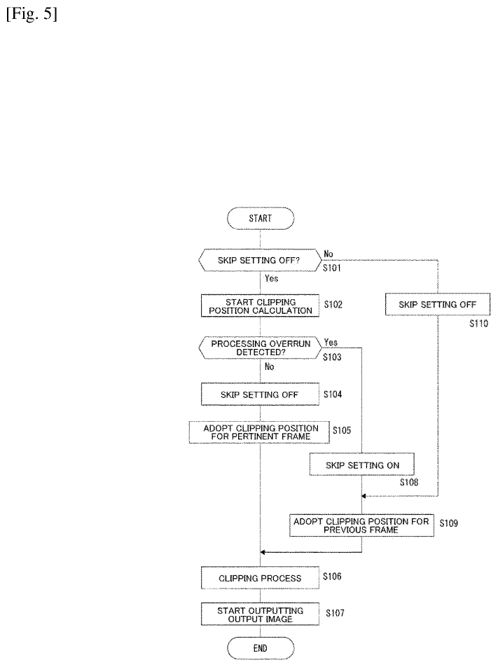

FIG. 5 shows a flowchart of a process performed by the image processing device 2 in the first embodiment. The process shown in FIG. 5 shows a process performed for one frame image Fi. Accordingly, the process shown in FIG. 5 is repeatedly performed for the number of frame images Fi.

At step S101, the image processing device 2 determines whether the skip setting is OFF. The skip setting is set to OFF in the initial state.

When determining that the skip setting is OFF at step S101, the image processing device 2 causes the clipping position calculation portion 27 to start a clipping position calculation process at step S102.

Then, at step S103, the image processing device 2 determines whether a processing overrun is detected. For example, this determination process is performed at the output timing of a stabilized image Si according to Sync2.

When determining that a processing overrun is not detected at step S103, the image processing device 2 sets the skip setting to OFF at step S104, and adopts the clipping position for the pertinent frame, that is, the latest clipping position, at step S105. The clipping frame Cf is thus updated.

At step S106, the image processing device 2 performs a clipping process based on the clipping position to generate a clipped image Ci from the frame image Fi.

At step S107, the image processing device 2 starts outputting an output image Oi.

When determining at step S103 that a processing overrun is detected, the image processing device 2 proceeds to step S108 and sets the skip setting to ON.

At step S109, the image processing device 2 adopts the clipping position of a previous frame (for example, the last frame). As a result, the clipping frame Cf of the previous frame is maintained.

After adopting the previous clipping frame Cf as the new clipping frame Cf, the image processing device 2 performs a clipping process at step S106, and starts outputting an output image Oi at step S107.

When determining at step S101 that the skip setting is set to ON, specifically, when a processing overrun has been detected for the previous frame, the image processing device 2 returns the skip setting to OFF at step S110 and adopts the clipping position for the previous frame at step S109. As a result, the clipping position calculated for the frame before the detection of a processing overrun, for example, is continuously adopted.

### 6. Second Embodiment

The countermeasure process for an occurrence of a processing overrun of a second embodiment is to delay the timing at which the stabilized image Si(N+1) is output from the stabilization process portion 25 (timing based on Vsync2).

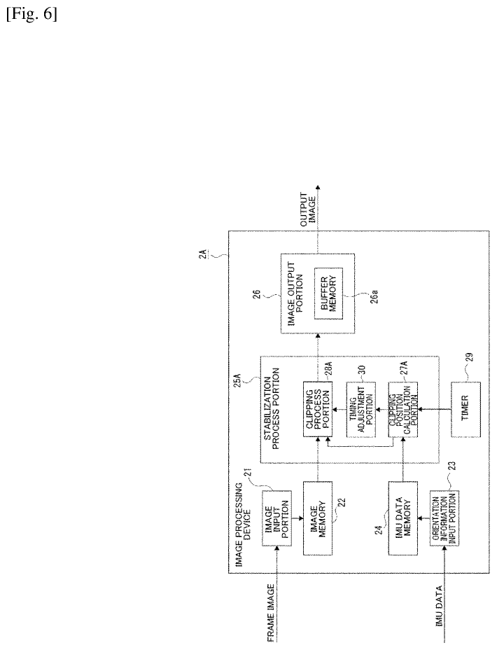

Referring to FIG. 6, a configuration example of an image processing device 2A of the present embodiment is first described. The same reference numerals are given to those configurations that are the same as the corresponding configurations shown in FIG. 2. Such configurations will not be described as appropriate.

The image processing device 2A is configured to include a stabilization process portion 25A and a timer 29 in addition to an image input portion 21, an image memory 22, an orientation information input portion 23, an IMU data memory 24, and an image output portion 26.

The timer 29 supplies time information to the stabilization process portion 25A to calculate the length of an overrun time To, which is the extra time taken in addition to the usual time, when a processing overrun occurs in a divisional stabilization process E.

The stabilization process portion 25A is configured to include a timing adjustment portion 30 in addition to a clipping position calculation portion 27A and a clipping process portion 28A.

The clipping position calculation portion 27A calculates the clipping position using the IMU data supplied from the orientation information input portion 23 via the IMU data memory 24, and sets the clipping frame Cf. At this time, the clipping position calculation portion 27A calculates the time required for the process using the time information supplied from the timer 29.

The clipping position calculation portion 27A supplies the clipping process portion 28A with information on the clipping frame Cf. This enables the clipping process portion 28A to generate a clipped image Ci corresponding to the clipping frame Cf.

The clipping position calculation portion 27A also determines the length of time required to calculate the clipping position when setting the clipping frame Cf. Then, when the time required for the process is longer than the predetermined time, the clipping position calculation portion 27A notifies the timing adjustment portion 30 to that effect.

Upon receiving this notification, the timing adjustment portion 30 instructs the clipping process portion 28A to delay the output timing of a stabilized image Si.

In response to this instruction, the clipping process portion 28A delays the output timing of the stabilized image Si for the next frame.

This delay process of output timing is performed in anticipation of the fact that the processing overrun that has occurred in the stabilization process for the current frame image Fi will affect the end timing of the stabilization process for the next frame image Fi.

The delay amount of the output timing is set within the range of a margin time Tm. The margin time Tm is variable according to the capacity of the buffer memory 26a of the image output portion 26.

Specifically, a stabilized image Si output from the clipping process portion 28A of the stabilization process portion 25A is temporarily stored in the buffer memory 26a of the image output portion 26 and then output from the image output portion 26 as an output image Oi after a predetermined time has elapsed.

Thus, the time between the storing into the buffer memory 26a and the output is the margin time Tm, which can absorb a delay in the stabilization process. That is, even when the output timing of a stabilized image Si output from the clipping process portion 28A is delayed by the margin time Tm, it can be absorbed by shortening the storage time in the buffer memory 26a.

When the time required for the stabilization process is longer than the normal time, the timing adjustment portion 30 instructs the clipping process portion 28A to delay the output of the stabilized image Si by a delay time Td.

This delay time Td may have the same time length as the overrun time To, for example.

In the example shown in FIG. 6, the time information from the timer 29 is input to the clipping position calculation portion 27A.

Originally, the determination on whether a processing overrun has occurred in a divisional stabilization process E requires the determination on whether the total of the time required for the clipping position calculation portion 27A of the stabilization process portion 25A to perform a calculation process of the clipping portion (setting process of the clipping frame Cf) and the time required for the clipping process portion 28A to perform a clipping process is longer than a predetermined time.

However, of the calculation process and clipping process of a clipping position, the time required for the clipping process is substantially constant. This allows the clipping position calculation portion 27A to independently identify the timing at which the clipping process ends on the basis of the time required for the clipping position calculation process.

As such, when time information from the timer 29 is input to the clipping position calculation portion 27A, the clipping position calculation portion 27A can determine whether a processing overrun will occur and thus can issue an instruction to the timing adjustment portion 30 as appropriate.

Nevertheless, the time information from the timer 29 may be input to the clipping process portion 28A, and the clipping process portion 28A may delay the output timing of the stabilized image Si. That is, when the timing of receiving the calculation result of the clipping position is delayed, the clipping process portion 28A may delay the output timing of the stabilized image Si so as to absorb the delay.

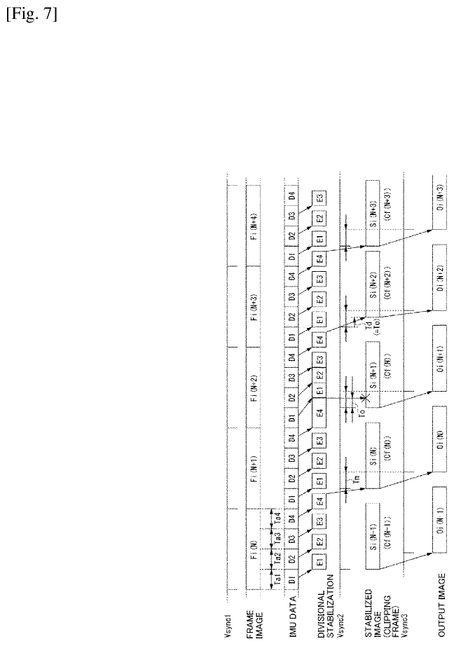

FIG. 7 shows the flow of process of the second embodiment.

First, a processing overrun does not occur in the divisional stabilization processes E1, E2, E3, and E4 for the Nth frame image Fi(N). Thus, as in the first countermeasure process, the stabilized image Si(N) is output from the stabilization process portion 25A at appropriate timing according to Vsync2, and the output image Oi(N) is output from the image processing device 2A at appropriate timing according to Vsync3.

Next, in the divisional stabilization processes E for the (N+1)th frame image Fi(N+1), the processing time of the divisional stabilization process E4 is prolonged, resulting in an occurrence of a processing overrun.

When a processing overrun occurs in the second embodiment, the clipping process portion 28A of the stabilization process portion 25A generates the stabilized image Si(N+1) using the frame image Fi(N+1) and the clipping frame Cf(N) at appropriate timing according to Vsync2.

That is, the clipping process portion 28A clips the clipped image Ci(N+1) from the latest frame image Fi(N+1) using the clipping frame Cf(N) of the last frame. As in the first embodiment, the stabilization process portion 25A thus outputs this clipped image Ci(N+1) as the stabilized image Si(N+1).

Also, in the present embodiment, according to an instruction from the timing adjustment portion 30, the clipping process portion 28A delays the output timing of the clipped image Ci from the next frame.

That is, as shown in FIG. 7, the clipping process portion 28A delays the output start timing of the stabilized image Si(N+2) for the frame image Fi(N+2) from Vsync2 by the delay time Td (=overrun time To).

To avoid further delay of the divisional stabilization process E4 for the frame image Fi(N+2) and to eliminate the delay if possible, the clipping position calculation portion 27A advances as much as possible the execution timing of the divisional stabilization processes E1, E2, and E3, which calculates the clipping position.

As a result, in the example shown in FIG. 7, the delay in the ending timing of the divisional stabilization process E4 for the frame image Fi(N+2) is eliminated.

When the end timing of the divisional stabilization process E4 returns to normal, that is, when the processing overrun is resolved, the clipping position calculation portion 27A notifies the timing adjustment portion 30 to that effect.

In response to this notification, the timing adjustment portion 30 instructs the clipping process portion 28A to cancel the setting of the delay time Td. As a result, the clipping process portion 28A returns the output timing of the clipped image Ci for the frame image Fi(N+3) to appropriate timing according to Vsync2.

By appropriately using the margin time Tm in this manner, it is possible to ensure that the output image Oi is an image on which the stabilization process is appropriately performed as much as possible.

Also, returning the output timing of the clipped image Ci (stabilized image Si) to an appropriate timing according to Vsync2 when the processing overrun is resolved can restore the margin time Tm.

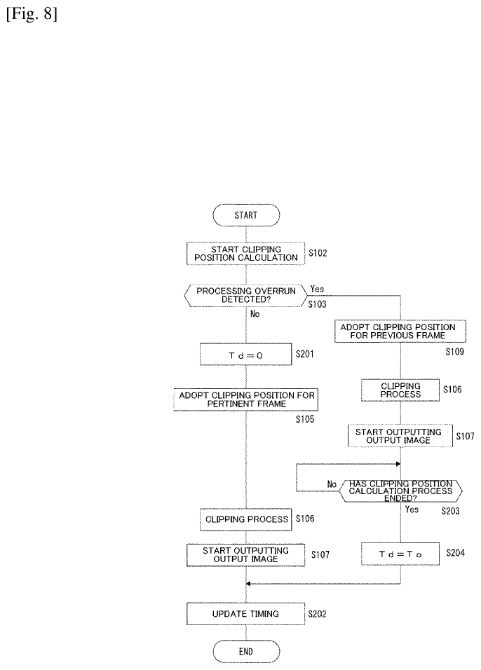

FIG. 8 shows a flowchart of a process performed by the image processing device 2 in the second embodiment. The process shown in FIG. 8 shows a process performed for one frame image Fi. Accordingly, the process shown in FIG. 8 is repeatedly performed for the number of frame images Fi.

The same step numbers are given to those processes that are the same as the corresponding processes shown in FIG. 5. Such processes will not be described in detail.

The image processing device 2 first starts calculating a clipping position at step S102 and determines whether a processing overrun is detected at the following step S103.

When a processing overrun is not detected, that is, when the calculation of the clipping position is completed, the image processing device 2 sets the delay time Td to “0” at step S201. As a result, the delay time Td is not applied to the timing at which the clipped image Ci (stabilized image Si) is output from the clipping process portion 28A, or the delay time Td set to 0 seconds is applied.

At step S105, the image processing device 2 adopts the clipping position for the pertinent frame, that is, the latest clipping position.

At step S106, the image processing device 2 performs a clipping process based on the latest clipping position to generate a clipped image Ci from the frame image Fi.

At step S107, the image processing device 2 starts outputting an output image Oi.

At step S202, the image processing device 2 updates the output timing of the clipped image Ci for the next frame. As a result, the clipped image Ci for the next frame is output from the clipping process portion 28A at the timing to which the delay time Td set in the previous step S201 is applied.

In contrast, when a processing overrun is detected at step S103, that is, when the calculation of the clipping position is not completed by the predetermined timing, the image processing device 2 adopts the clipping position of the previous frame at step S109.

Then, the image processing device 2 performs a clipping process based on the clipping position at step S106, and starts outputting the output image Oi at step S107.

At step S203, the image processing device 2 determines whether the clipping position calculation process has ended. Then, the process of step S203 is looped until the clipping position calculation process ends.

The overrun time To is determined at the end timing of the clipping position calculation process. Thus, when determining that the clipping position calculation process has ended, the image processing device 2 sets the delay time Td to the overrun time To at step S204.

Then, at step S202, the image processing device 2 updates the output timing of the clipped image Ci for the next frame. As a result, the output timing of the clipped image Ci is delayed by the delay time Td in the frame subsequent to the detection of the over processing.

### 7. Third Embodiment

The countermeasure process for an occurrence of a processing overrun of a third embodiment is a combination of the countermeasure process of the first embodiment and the countermeasure process of the second embodiment.

Since the configuration of the image processing device 2A is the same as that of the second embodiment shown in FIG. 6, the description thereof is omitted.

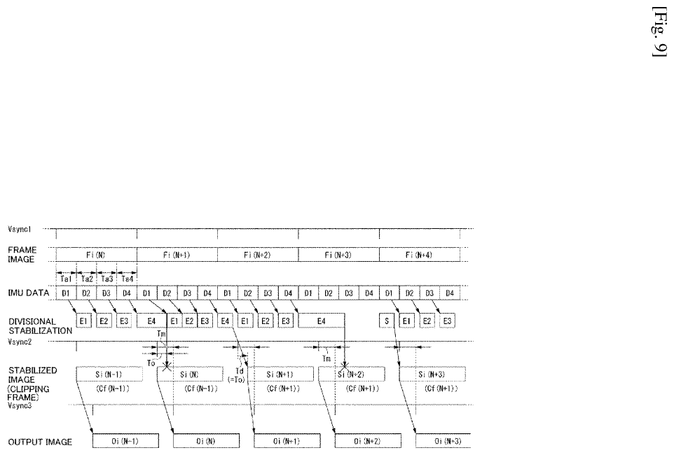

Referring to FIG. 9, the flow of process of the third embodiment is specifically described.

First, for the (N−1)th frame image Fi(N?1), the output image Oi(N−1) is output using the clipping frame Cf(N?1) set by the clipping position calculated as the result of the divisional stabilization processes E1, E2, E3, and E4. That is, a processing overrun is not detected for the (N−1)th frame image Fi(N−1).

For the subsequent Nth frame image Fi(N), the processing time of the divisional stabilization process E4 is prolonged, resulting in an occurrence of a processing overrun.

However, the overrun time To, which is the time during which a processing overrun occurs, is shorter than the margin time Tm.

Accordingly, by setting the delay time Td (=To) as in the second embodiment, the output timing of the stabilized image Si(N+1) for the (N+1)th frame image Fi(N+1) is delayed by the delay time Td from the timing defined by Vsync2.

As for the clipping frame Cf for the frame image Fi(N), since the clipping frame Cf(N) was not set in time, the clipping frame Cf(N?1) calculated for the frame image Fi(N?1) of the last frame is adopted.

Subsequently, although the output timing of the stabilized image Si(N+1) for the (N+1)th frame image Fi(N+1) is delayed by the delay time Td, the processing overrun is resolved for the end timing of the divisional stabilization process E4 for the frame image Fi(N+1).

As such, the output timing of the stabilized image Si(N+1) for the next (N+2)th frame image Fi(N+2) is returned to the timing defined by Vsync2 without the delay time Td applied.

However, the processing time of the divisional stabilization process E4 for the (N+2)th frame image Fi(N+2) is prolonged, resulting in an occurrence of a processing overrun. Additionally, the overrun time To for this processing overrun is too long to absorb with the margin time Tm.

In this case, as in the first embodiment, the execution of the divisional stabilization processes E for the next frame image Fi(N+3) is skipped to restore a state in which a normal stabilization process can be performed.

As shown in FIG. 9, even when a processing overrun occurs frequently, the clipping frame Cf is appropriately updated with a reduced frequency. As a result, even when the stabilization process is not completed in time, it is possible to output an output image Oi in which the stabilization function is effective to some extent.

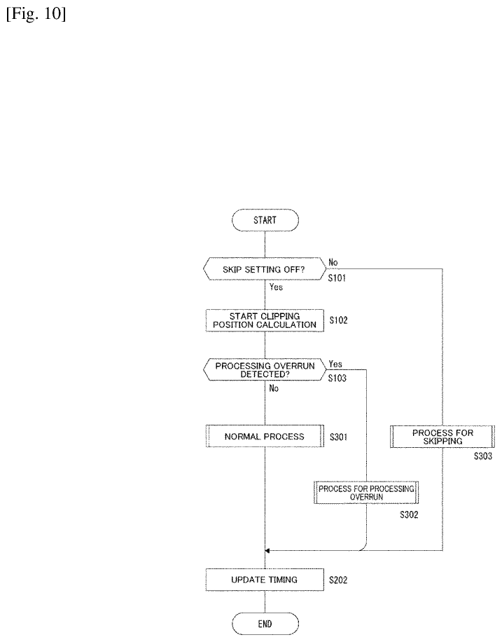

FIGS. 10, 11, 12, and 13 show flowcharts of processes performed by the image processing device 2A of the third embodiment. The process shown in FIG. 10 shows a process performed for one frame image Fi. Accordingly, the process shown in FIG. 10 is repeatedly performed for the number of frame images Fi.

The same step numbers are given to those processes that are the same as the corresponding processes shown in FIGS. 5 and 8. Such processes will not be described in detail.

At step S101, the image processing device 2A determines whether the skip setting is OFF. The skip setting is set to OFF in the initial state.

When determining that the skip setting is OFF at step S101, the image processing device 2A causes the clipping position calculation portion 27 to start a clipping position calculation process at step S102.

Then, at step S103, the image processing device 2A determines whether a processing overrun is detected. For example, this determination process is performed at the output timing of a stabilized image Si according to Sync2.

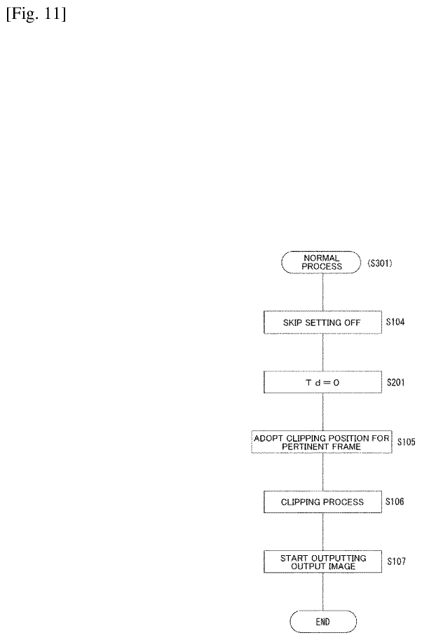

When determining that a processing overrun is not detected at step S103, the image processing device 2A performs the normal process shown in FIG. 11 at step S301.

In the normal process shown in FIG. 11, the image processing device 2A first sets the skip setting to OFF at step S104. The process at step S104 may be skipped when the skip setting is already OFF.

Then, since the output timing for the stabilized image Si for the next frame does not have to be delayed, the image processing device 2A sets the delay time Td to “0” at step S201.

At step S105, the image processing device 2A adopts the clipping position for the pertinent frame, that is, the latest clipping position.

The image processing device 2A performs a clipping process based on the clipping position at step S106 and starts outputting the output image Oi at the next step S107.

The image processing device 2A returns to the process in FIG. 10 and updates the output timing of the clipped image Ci for the next frame at step S202. Specifically, the output timing is set on the basis of the delay time Td (=“0”) set at step S201 in FIG. 11.

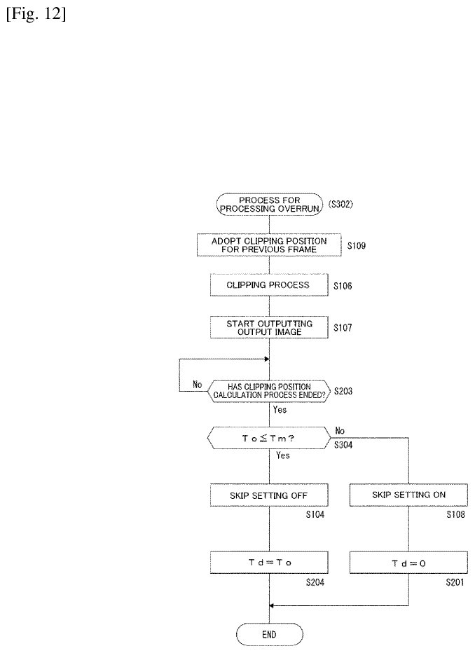

When determining that a processing overrun is detected at step S103, the image processing device 2A proceeds to step S302 and performs a process for processing overrun shown in FIG. 12.

In the process for processing overrun, the image processing device 2A first adopts the clipping position for the previous frame at step S109 shown in FIG. 12.

Then, the image processing device 2A performs a clipping process based on the clipping position at step S106 and starts outputting the output image Oi at the next step S107.

At step S203, the image processing device 2A determines whether the clipping position calculation process has ended. Then, the process of step S203 is looped until the clipping position calculation process ends.

When determining that the clipping position calculation process has ended, the image processing device 2A determines at step S304 whether the overrun time To is less than or equal to the margin time Tm. A situation in which the overrun time To is less than or equal to the margin time Tm corresponds to a situation in which the prolonged portion of the processing time of the divisional stabilization process E can be absorbed by consuming the margin time Tm.

When the image processing device 2A determines that the overrun time To is less than or equal to the margin time Tm, the skip setting is set to OFF at step S104.

The image processing device 2A returns to the process in FIG. 10 and updates the output timing of the clipped image Ci for the next frame at step S202. Specifically, the output timing is delayed on the basis of the delay time Td (=“To”) set at step S204 in FIG. 12.

When determining that the overrun time To is greater than the margin time Tm at S304 in FIG. 12, the image processing device 2A sets the skip setting to ON at step S108.

By setting this skip setting to ON, the divisional stabilization processes E for the next frame are skipped. Thus, since the output timing for the stabilized image Si for the next frame does not have to be delayed, the image processing device 2A set the delay time Td to “0” at step S201.

The image processing device 2A returns to the process in FIG. 10 and updates the output timing of the clipped image Ci for the next frame at step S202. Specifically, the output timing is set on the basis of the delay time Td (=“0”) set at step S201 in FIG. 12.

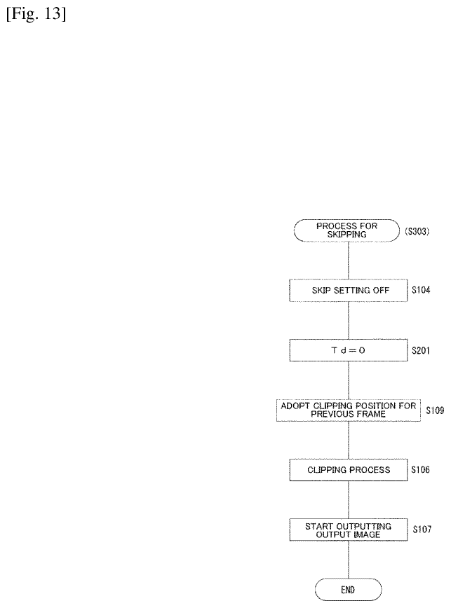

When the skip setting is determined to be set to “ON” at step S101 shown in FIG. 10, specifically, when a processing overrun occurs in the previous frame and the overrun time To is too long to be absorbed, the image processing device 2A performs a process for skipping shown in FIG. 13 at step S303.

In the process for skipping, the image processing device 2A first returns the skip setting to OFF at step S104.

Then, since it may not be necessary to delay the output timing for the stabilized image Si for the next frame, the image processing device 2A sets the delay time Td to “O” at step S201.

The clipping position for the pertinent frame cannot be calculated because the stabilization process is skipped. Thus, the image processing device 2A adopts the clipping position for the previous frame at step S109.

The image processing device 2A performs a clipping process based on the clipping position at step S106 and starts outputting the output image Oi at the next step S107.

The image processing device 2A returns to the process in FIG. 10 and updates the output timing of the clipped image Ci for the next frame at step S202. Specifically, the output timing is set on the basis of the delay time Td (=“0”) set at step S201 in FIG. 13.

As a result, even when the stabilization process takes too long to be absorbed with the margin time Tm, the clipped image Ci is clipped from the latest frame image Fi on the basis of the appropriate clipping position calculated as late as possible. This allows an image in which the stabilization function is effective as much as possible to be output as the output image Oi.

### 8. Fourth Embodiment

The countermeasure process for an occurrence of a processing overrun of a fourth embodiment is to reduce the computation amount of the stabilization process.

The configuration of the image processing device 2 in this embodiment is the same as that of the first embodiment and shown in FIG. 2.

However, the clipping position calculation portion 27 determines whether a processing overrun has occurred in the clipping position calculation process and switches the processing methods so as not to use part of the IMU data when a processing overrun is detected. Specifically, the clipping position calculation portion 27 does not use part of the partial IMU data D for processing after detecting a processing overrun. This processing mode is described as a “thinning mode”. Also, a divisional stabilization process E performed in the thinning mode is described as a “thinning stabilization process”.

At this time, the clipping position calculation portion 27 may instruct the orientation information input portion 23 not to store the partial IMU data D that is not used for processing in the IMU data memory 24 in the subsequent stage.

In the thinning mode, the clipping position calculation portion 27 does not use the partial IMU data D2 and D4 among the partial IMU data D1, D2, D3, and D4 for the stabilization process, for example.

That is, as the thinning stabilization process in the thinning mode, the clipping position calculation portion 27 performs the divisional stabilization process E1 and also performs, as the divisional stabilization process E2, the process that was formerly performed as the divisional stabilization process E3. Then, for the next frame image Fi, the process that was formerly performed as the divisional stabilization process El is performed as the divisional stabilization process E3, and the process that was formerly performed as the divisional stabilization process E3 is performed as the divisional stabilization process E4.

These four divisional stabilization processes E are performed as one set of thinning stabilization processes.

As a result, the clipping position calculation portion 27 performs one calculation process of a clipping position over two frames. That is, the calculation rate of the clipping position and the setting rate of the clipping frame Cf are set to half of the normal rate.

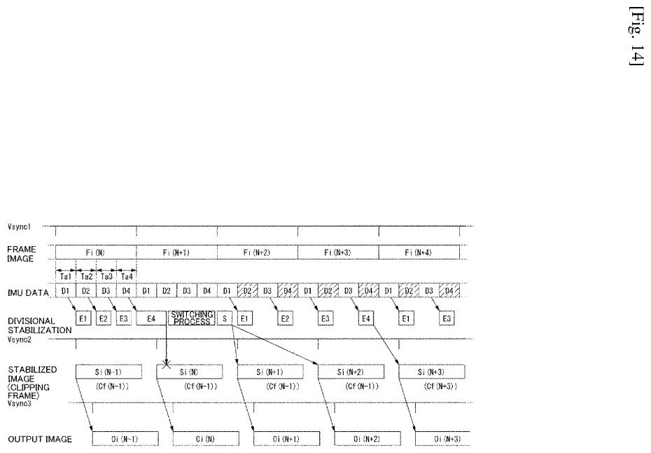

Referring to FIG. 14, the flow of process of the fourth embodiment is specifically described.

First, for the (N−1)th frame image Fi(N?1), the output image Oi(N−1) is output using the clipping frame Cf(N?1) set by the clipping position calculated as the result of the divisional stabilization processes E1, E2, E3, and E4. That is, a processing overrun is not detected for the (N−1)th frame image Fi(N−1).

For the subsequent Nth frame image Fi(N), the processing time of the divisional stabilization process E4 is prolonged, resulting in an occurrence of a processing overrun. The present embodiment performs a switching process to the thinning stabilization process when a processing overrun occurs. Specifically, a switching process to the thinning stabilization process is performed instead of performing the stabilization process for the next frame.

As such, firstly, for the Nth frame image Fi(N), since the stabilization process is not completed in time, the clipping frame Cf(N?1) is set on the basis of the clipping position calculated for the last (N−1)th frame image Fi(N−1), and the clipped image Ci(N) is generated.

As for the (N+1)th frame image Fi(N+1), since the stabilization process is skipped, the clipping frame Cf(N?1) is set on the basis of the same clipping position as the last frame image Fi(N), that is, the clipping position calculated for the frame image Fi(N?1), and the clipped image Ci(N+1) is generated.

Then, the thinning stabilization process starts from the (N+2)th frame image Fi(N+2). However, since one set of thinning stabilization processes has not been completed for the (N+2)th frame image Fi(N+2), the clipping frame Cf(N−1) is set on the basis of the same clipping position as the last frame image Fi(N), that is, the clipping position calculated for the frame image Fi(N−1), in a similar manner, and the clipped image Ci(N+2) is generated.

For the (N+3)th frame image Fi(N+3), a new clipping position calculated by one set of thinning stabilization processes is available. Thus, the clipping frame Cf (N+3) is set according to the newly calculated clipping position, and the clipped image Ci(N+3) is clipped.

Thereafter, although not shown in FIG. 14, new clipping positions are adopted at the timing of the frame image Fi(N+5) and the frame image Fi(N+7).

For the frame image Fi(N+4) and the frame image Fi(N+6), the clipping position of the last frame is adopted.

It should be noted that the frame image Fi that is subjected to a clipping process is updated even for a frame for which the clipping position is not updated.

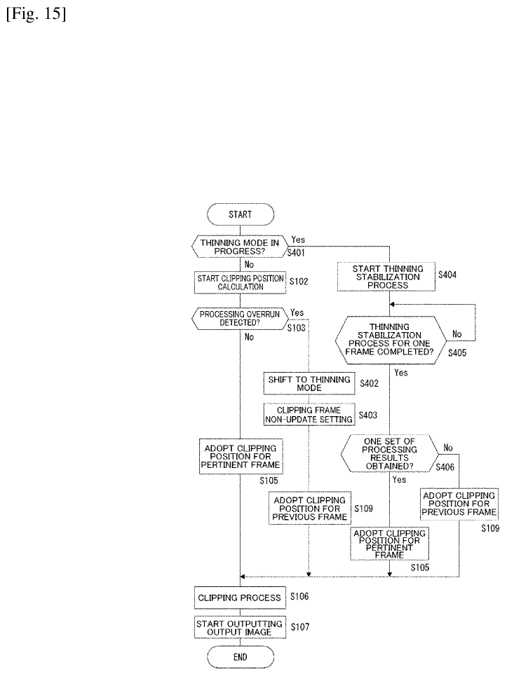

FIG. 15 shows a flowchart of a process performed by the image processing device 2 in the fourth embodiment. The process shown in FIG. 15 is a process performed for one frame image Fi. Accordingly, the process shown in FIG. 15 is repeatedly performed for the number of frame images Fi.

The same step numbers are given to those processes that are the same as the corresponding processes shown in FIGS. 5 and 8. Such processes will not be described in detail.

First, at step S401, the image processing device 2 determines whether the thinning mode is in progress. When determining that the thinning mode is not in progress, the image processing device 2 proceeds to step S102 and starts a clipping position calculation process. For example, the image processing device 2 determines that the Nth frame shown in FIG. 14 is not in the thinning mode.

Then, at step S103, the image processing device 2 determines whether a processing overrun is detected. When determining that a processing overrun is not detected, the image processing device 2 adopts the clipping position for the pertinent frame, that is, the latest clipping position, at step S105.

Then, the image processing device 2 performs a clipping process based on the clipping position at step S106, and starts outputting the output image Oi at step S107.

When determining that a processing overrun is detected at step S103, the image processing device 2 shifts to the thinning mode at step S402. For example, the image processing device 2 determines that a processing overrun is detected for the Nth frame shown in FIG. 14.

After shifting to the thinning mode, the image processing device 2 performs a non-update setting process for the clipping frame Cf at step S403. This non-update setting process is a process of setting such that the clipping frame Cf set for the frame immediately before the pertinent frame is adopted as the clipping frame Cf for the pertinent frame image Fi and the clipping frame Cf for the next frame image Fi.

Then, at step S109, the image processing device 2 adopts the clipping position for the previous frame, that is, the clipping frame Cf, on the basis of the non-update setting process.

Then, the image processing device 2 performs a clipping process based on the clipping position at step S106, and starts outputting the output image Oi at step S107.

When determining that the thinning mode is in progress at step S401, the image processing device 2 starts a thinning stabilization process for the pertinent frame image Fi at step S404. For example, for the (N+2)th frame and the (N+3)th frame shown in FIG. 14, it is determined that the thinning mode is in progress.

At step S405, the image processing device 2 determines whether the thinning stabilization process for the pertinent frame has been completed. For example, for the (N+2)th frame shown in FIG. 14, this determination process is a process of determining whether the divisional stabilization processes E1 and E2 performed as thinning stabilization processes have been completed. Also, for the (N+3)th frame, this determination process is a process of determining whether the divisional stabilization processes E3 and E4 performed as thinning stabilization processes have been completed.

The process of step S405 is repeated until the thinning stabilization processes for the pertinent frame are completed.

When determining that at step S405 that the thinning stabilization process has been completed, the image processing device 2 determines at step S406 whether one set of processing results is obtained. For example, for the (N+2)th frame shown in FIG. 14, only the divisional stabilization processes E1 and E2 are completed as thinning stabilization processes, and it is thus determined that one set of processing results is not obtained. In contrast, for the (N+3)th frame shown in FIG. 14, since the divisional stabilization processes E1, E2, E3, and E4 are completed as thinning stabilization processes, it is determined that one set of processing results is obtained.

When determining at step S406 that one set of processing results is obtained, the image processing device 2 adopts the clipping position for the pertinent frame, that is, the latest clipping position, at step S105. The clipping position and clipping frame Cf adopted at this time are obtained as a result of the stabilization processes over two frames.

In contrast, when determining at step S406 that one set of processing results is not obtained, the image processing device 2 adopts the clipping position of the previous frame at step S109.

After completing the process of step S105 or step S109, the image processing device 2 proceeds to step S106.

When the series of processes shown in FIG. 15 continues to be performed, the process does not return to the normal mode when a processing overrun occurs and once the mode is transitioned to the thinning mode.

To solve this, the image processing device 2 may be configured to appropriately transition to the normal mode after a certain period of time, such as several hundred milliseconds or several seconds, has elapsed after transitioning to the thinning mode.

In addition to transitioning to the normal mode after a lapse of time, various examples may be contemplated, such as transitioning to the normal mode at the time when the movement of the camera device 1 becomes smaller on the basis of the IMU data.

### 9. Fifth Embodiment

The countermeasure process for an occurrence of a processing overrun of a fifth embodiment is to reduce the computation amount of the stabilization process by a method different from the fourth embodiment.

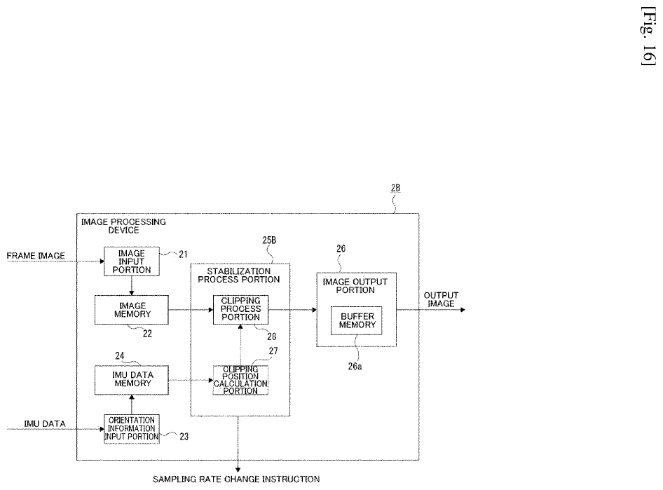

FIG. 16 shows a configuration example of an image processing device 2B according to the present embodiment. The same reference numerals are given to those configurations that are the same as the corresponding configurations in FIG. 2.

The stabilization process portion 25B in the image processing device 2B determines whether a processing overrun has occurred in a clipping position calculation process and, when detecting a processing overrun, instructs the IMU 5 shown in FIG. 1 to change the sampling rate.

This change instruction serves as an instruction for lowering the sampling rate of the IMU 5 from a first sampling rate H1 to a lower second sampling rate H2.

This reduces the amount of IMU data calculated by the IMU 5, specifically the data amount of the partial IMU data D1, D2, D3, and D4. Here, the partial IMU data with a reduced data amount is referred to as partial IMU data Da (Da1, Da2, Da3, Da4).

Accordingly, the computation amount of the divisional stabilization processes E in the clipping position calculation portion 27 is reduced, and the processing time of the divisional stabilization processes E can be shortened.

That is, it is possible to create a state in which a processing overrun is less likely to occur.

The divisional stabilization processes with small amounts of computation performed in the simple stabilization process that is performed on the basis of partial IMU data Da1, Da2, Da3, and Da4 with reduced data amounts are referred to as divisional stabilization processes F1, F2, F3, and F4. A mode in which the simple stabilization process is performed is referred to as a “simple mode”.

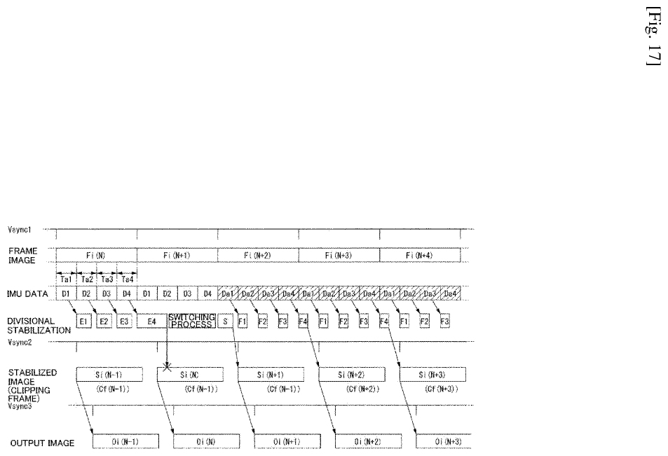

Referring to FIG. 17, the flow of process of the fifth embodiment is specifically described.

First, for the (N−1)th frame image Fi(N?1), the output image Oi(N−1) is output using the clipping frame Cf(N?1) set by the clipping position calculated as the result of the divisional stabilization processes E1, E2, E3, and E4. That is, a processing overrun is not detected for the (N−1)th frame image Fi(N−1).

For the subsequent Nth frame image Fi(N), the processing time of the divisional stabilization process E4 is prolonged, resulting in an occurrence of a processing overrun. The present embodiment performs a switching process to the simple mode that performs a simple stabilization process when a processing overrun occurs. Specifically, the execution of a stabilization process for the next (N+1)th frame image Fi(N+1) is canceled, and a switching process to a simple stabilization process is performed instead.

As such, firstly, for the Nth frame image Fi(N), since the stabilization process is not completed in time, the clipping frame Cf(N?1) is set on the basis of the clipping position calculated for the last (N−1)th frame image Fi(N−1), and the clipped image Ci(N) is generated.

As for the (N+1)th frame image Fi(N+1), since the stabilization process is skipped, the clipping frame Cf(N?1) is set on the basis of the same clipping position as the last frame image Fi(N), that is, the clipping position calculated for the frame image Fi(N?1), and the clipped image Ci(N+1) is generated.

Then, a simple stabilization process starts from the (N+2)th frame image Fi(N+2).

In the simple stabilization process, the divisional stabilization process F1 as a simple stabilization process is performed on the basis of the partial IMU data Da obtained at a reduced sampling rate.

As shown, the partial IMU data Da is indicated by diagonal hatching. Also, since the data amount of the partial IMU data Da is reduced, the computation time of the divisional stabilization process F1 is shorter than that of the divisional stabilization process El and the like.

In the divisional stabilization process F for the (N+2)th frame image Fi(N+2), since a processing overrun is not detected, the clipping frame Cf(N+2) and the clipped image Ci(N+2) clipped on the basis of the calculated new clipping position.

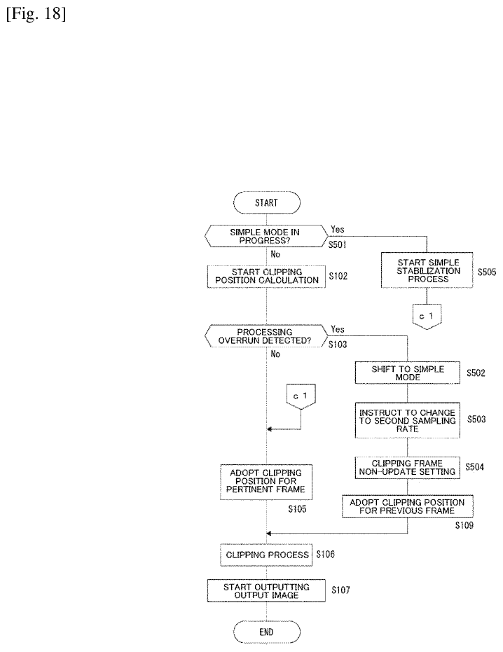

FIG. 18 shows a flowchart of a process performed by the image processing device 2 in the fifth embodiment. The process shown in FIG. 18 is a process performed for one frame image Fi. Accordingly, the processing shown in FIG. 18 is repeatedly performed for the number of frame images Fi.

The same step numbers are given to those processes that are the same as the corresponding processes shown in FIGS. 5 and 8. Such processes will not be described in detail. In FIG. 18, parts of the flow of process are connected by connectors c1.

First, at step S501, the image processing device 2 determines whether the simple mode is in progress. When determining that the simple mode is not in progress, the image processing device 2 proceeds to step S102 and starts a clipping position calculation process for the pertinent frame image Fi. For example, for the Nth frame shown in FIG. 17, the image processing device 2 determines that the simple mode is not in progress.

Then, at step S103, the image processing device 2 determines whether a processing overrun is detected. When determining that a processing overrun is not detected, the image processing device 2 proceeds to step S105. Since the subsequent processes are the same as the processes in the fourth embodiment, the description is omitted.

When detecting an occurrence of a processing overrun at step S103, the image processing device 2 shifts to the simple mode at step S502. For example, the image processing device 2 determines that a processing overrun is detected for the Nth frame shown in FIG. 17.

After shifting to the simple mode, the image processing device 2 supplies an instruction to the IMU 5 to change from the first sampling rate H1 to the second sampling rate H2 at step S503. As a result, the sampling rate in the IMU 5 is changed to a lower rate.

Subsequently, at step S504, the image processing device 2 performs a non-update setting process for the clipping frame Cf. This non-update setting process is a process of setting such that the clipping frame Cf set for the frame immediately before the pertinent frame is adopted as the clipping frame Cf for the pertinent frame image Fi.

Then, at step S109, the image processing device 2 adopts the clipping position for the previous frame, that is, the clipping frame Cf, on the basis of the non-update setting process.

Then, the image processing device 2 performs a clipping process based on the clipping position at step S106, and starts outputting the output image Oi at step S107.

When determining that the simple mode is in progress at step S501, the image processing device 2 starts the simple stabilization process for the pertinent frame image Fi at step S505. For example, for the (N+2)th frame and the (N+3)th frame shown in FIG. 17, it is determined that the simple mode is in progress.

After starting the simple stabilization process, the image processing device 2 adopts the clipping position for the pertinent frame, that is, the latest clipping position, at step S105, and performs the processes of steps S106 and S107.

As in the fourth embodiment, the image processing device 2 may be configured to appropriately transition to the normal mode after a certain period of time, such as several hundred milliseconds or several seconds, has elapsed after transitioning to the simple mode.

Alternatively, in addition to transitioning to the normal mode after a lapse of time, various examples may be contemplated, such as transitioning to the normal mode at the time when the movement of the camera device 1 becomes smaller on the basis of the IMU data.

Also, in FIG. 18, it is assumed that a processing overrun does not occur in the simple mode, but it may be considered that a processing overrun occurs even in the simple mode.

For example, after starting the simple stabilization process at step S505 in FIG. 18, the image processing device 2 may determine whether a processing overrun is detected at step S103.

Then, when a processing overrun is detected in the simple stabilization process, the image processing device 2 may proceed to steps S502 and S503 to further reduce the sampling rate.

With such a configuration, it is possible to continue lowering the sampling rate until a processing overrun no longer occurs, and the IMU 5 can be adjusted so that an appropriate stabilized image Si is output.

### 10. Sixth Embodiment

The countermeasure process for an occurrence of a processing overrun of a sixth embodiment is to reduce the computation amount of the stabilization process by a method different from the fifth embodiment.

Since the configuration of the image processing device 2 in the present embodiment is the same as that shown in FIG. 2, the description is omitted.

However, the clipping position calculation portion 27 of the image processing device 2 discards part of the IMU data input via the IMU data memory 24 and performs a clipping position calculation process. That is, the sampling rate of the IMU 5 is not changed.

The stabilization process that is performed with part of the input IMU data discarded is referred to as a simple stabilization process, as in the fifth embodiment. The divisional stabilization process performed in the simple stabilization process is referred to as a divisional stabilization process F1. A mode in which the simple stabilization process is performed is referred to as a “simple mode”.

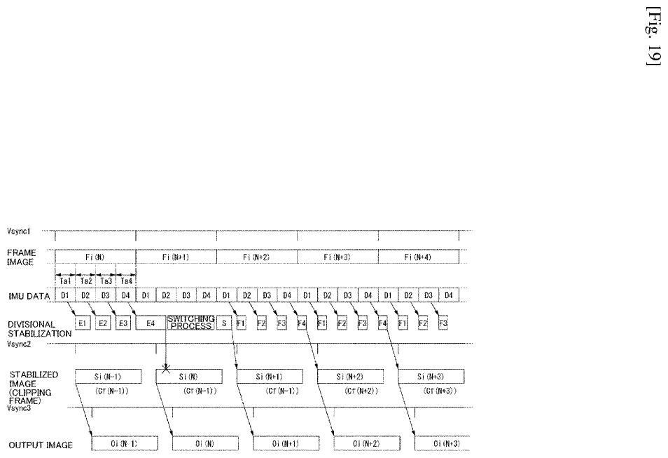

Referring to FIG. 19, the flow of process of the sixth embodiment is specifically described.

First, for the (N−1)th frame image Fi(N?1), the output image Oi(N−1) is output using the clipping frame Cf(N?1) set by the clipping position calculated as the result of the divisional stabilization processes E1, E2, E3, and E4. That is, a processing overrun is not detected for the (N−1)th frame image Fi(N−1).

For the subsequent Nth frame image Fi(N), the processing time of the divisional stabilization process E4 is prolonged, resulting in an occurrence of a processing overrun. The present embodiment performs a switching process to the simple mode that performs a simple stabilization process when a processing overrun occurs. Specifically, the execution of a stabilization process for the next (N+1)th frame image Fi(N+1) is canceled, and a switching process to a simple stabilization process is performed instead.

As such, firstly, for the Nth frame image Fi(N), since the stabilization process is not completed in time, the clipping frame Cf(N?1) is set on the basis of the clipping position calculated for the last (N−1)th frame image Fi(N−1), and the clipped image Ci(N) is generated.

As for the (N+1)th frame image Fi(N+1), since the stabilization process is skipped, the clipping frame Cf(N−1) is set on the basis of the same clipping position as the last frame image Fi(N), that is, the clipping position calculated for the frame image Fi(N?1), and the clipped image Ci(N+1) is generated.

Then, a simple stabilization process starts from the (N+2)th frame image Fi(N+2). In the simple stabilization process, the divisional stabilization process F1 is performed with part of the input partial IMU data D discarded.

As shown, the partial IMU data D itself does not change from a state before shifting to the simple mode. Since part of the partial IMU data D is discarded, the computation time of the divisional stabilization process F1 is shorter than that of the divisional stabilization process E1.

In the divisional stabilization processes F for the (N+2)th frame image Fi(N+2), since a processing overrun is not detected, the clipping frame Cf(N+2) is set on the basis of the calculated new clipping position, and the clipped image Ci(N+2) is clipped.

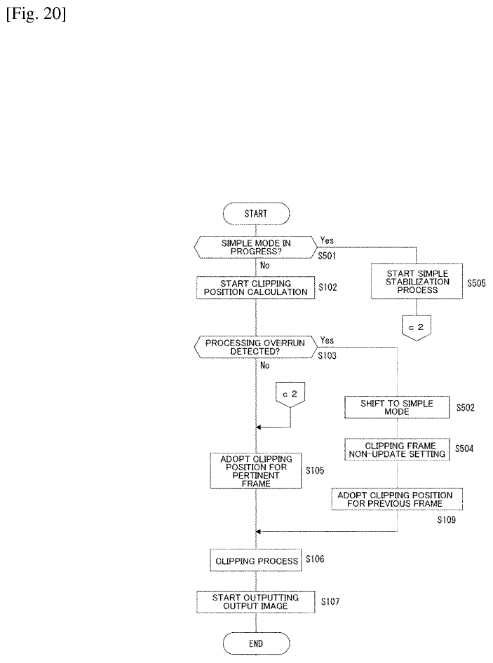

FIG. 20 shows a flowchart of a process performed by the image processing device 2 in the sixth embodiment. The process shown in FIG. 20 is a process performed for one frame image Fi. Accordingly, the process shown in FIG. 20 is repeatedly performed for the number of frame images Fi.

The same step numbers are given to those processes that are the same as processing of FIGS. 5, 8, and 18. Such processes will not be described in detail. In addition, in FIG. 20, parts of the flow of processing are connected by connectors c2.

First, at step S501, the image processing device 2 determines whether the simple mode is in progress. When determining that the simple mode is not in progress, the image processing device 2 proceeds to step S102 and starts a clipping position calculation process for the pertinent frame image Fi. For example, for the Nth frame shown in FIG. 19, the image processing device 2 determines that the simple mode is not in progress.

Then, at step S103, the image processing device 2 determines whether a processing overrun is detected. When determining that a processing overrun is not detected, the image processing device 2 proceeds to step S105. Since the subsequent processes are the same as the processes in the fifth embodiment, the description is omitted.

When detecting an occurrence of a processing overrun at step S103, the image processing device 2 shifts to the simple mode at step S502. For example, the image processing device 2 determines that a processing overrun is detected for the Nth frame shown in FIG. 19.

After shifting to the simple mode, the image processing device 2 performs a non-update setting process for the clipping frame Cf at step S504. This non-update setting process is a process of setting such that the clipping frame Cf set for the frame immediately before the pertinent frame is adopted as the clipping frame Cf for the pertinent frame image Fi. Also, unlike the fifth embodiment shown in FIG. 18, the image processing device 2 of this embodiment does not change the sampling rate of the IMU 5.

Then, at step S109, the image processing device 2 adopts the clipping position for the previous frame, that is, the clipping frame Cf, on the basis of the non-update setting process.

Then, the image processing device 2 performs a clipping process based on the clipping position at step S106, and starts outputting the output image Oi at step S107.

When determining that the simple mode is in progress at step S501, the image processing device 2 starts the simple stabilization process for the pertinent frame image Fi at step S505. For example, for the (N+2)th frame and the (N+3)th frame shown in FIG. 19, it is determined that the simple mode is in progress.

After starting the simple stabilization process, the image processing device 2 adopts the clipping position for the pertinent frame, that is, the latest clipping position, at step S105, and performs the processes of steps S106 and S107.

As in the fifth embodiment, the image processing device 2 may be configured to appropriately transition to the normal mode after a certain period of time, such as several hundred milliseconds or several seconds, has elapsed after transitioning to the simple mode.

Alternatively, in addition to transitioning to the normal mode after a lapse of time, various examples may be contemplated, such as transitioning to the normal mode at the time when the movement of the camera device 1 becomes smaller on the basis of the IMU data.

Also, in FIG. 20, it is assumed that a processing overrun does not occur in the simple mode, but it may be considered that a processing overrun occurs even in the simple mode as in the fifth embodiment.

For example, when a processing overrun occurs in the simple mode, the data to be discarded in the input partial IMU data D may be increased.

This configuration can reduce the IMU data used for the stabilization process until a processing overrun no longer occurs.

### 11. Modifications

Various modifications applicable to the examples described above are now described.

### <11-1. First Modification>

In a first modification, an image processing device 2C has a configuration for increasing the margin time Tm described in the second and third embodiments.

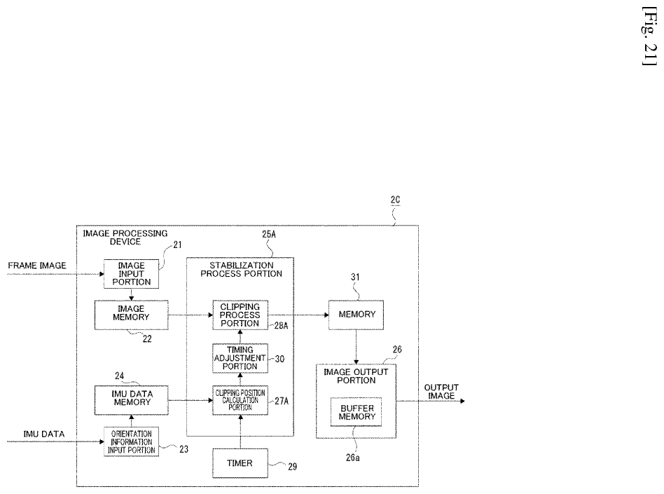

Specifically, as shown in FIG. 21, the image processing device 2C includes a memory 31 in addition to an image input portion 21, an image memory 22, an orientation information input portion 23, an IMU data memory 24, a stabilization process portion 25A, and an image output portion 26.

For example, the memory 31 has a storage region capable of storing a frame image Fi for one frame.

This allows for a longer interval between the output timing of the stabilized image Si (timing based on Vsync2) and the output timing of the output image Oi (timing based on Vsync3). That is, the margin time Tm can be extended.

Thus, the margin time Tm can absorb a longer overrun time To when a processing overrun occurs.

<11-2. Second Modification>A second modification uses the clipping position and clipping frame Cf calculated when a processing overrun occurs.

For example, in the first embodiment, a processing overrun occurs in the (N+1)th frame image Fi(N+1). However, since the divisional stabilization process E4 is completed even though a processing overrun occurs, the clipping position and clipping frame Cf for the frame image Fi(N+1) are already calculated even though they are not adopted.

In the present modification, the clipping frame Cf that is not adopted for the pertinent frame image Fi due to the processing overrun is adopted as the clipping frame Cf for the next frame image Fi.

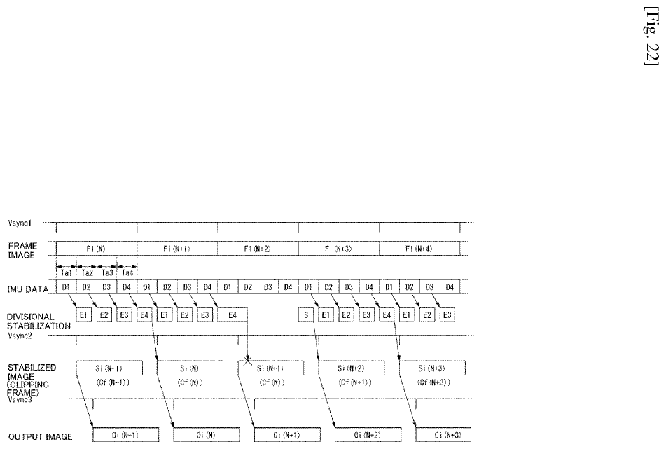

This is specifically illustrated in FIG. 22.

For the frame image Fi(N+1), the end timing of the divisional stabilization process E4 fails to meet the output timing of the stabilized image Si, so that the clipping frame Cf(N) for the last frame image Fi(N) is used to generate the stabilized image Si(N+1).

Then, since the divisional stabilization process E itself is skipped for the frame image Fi(N+2), the stabilized image Si(N+2) is generated using the clipping frame Cf for a previous frame image Fi.

At this time, the above first embodiment uses the clipping frame Cf(N) for the second last frame image Fi(N), but the present modification adopts the clipping frame Cf(N+1) calculated with a delay for the last frame image Fi(N+1).

This allows for the output of an output image Oi in which the stabilization function is effective as much as possible.

This configuration may also be applied to other embodiments.

For example, in the third embodiment, the stabilized image Si(N+3) can be generated for the frame image Fi(N+3) shown in FIG. 9 by adopting the clipping frame Cf (N+2) instead of the clipping frame Cf (N+1).

Also, in the fourth embodiment, the stabilized images Si(N+1) and Si(N+2) for the frame images Fi(N+1) and Fi(N+2) shown in FIG. 14 can be generated by adopting the clipping frame Cf(N) instead of the clipping frame Cf(N−1).

Furthermore, in the fifth embodiment, the stabilized image Si(N+1) for the frame image Fi(N+1) shown in FIG. 17 can be generated by adopting the clipping frame Cf(N) instead of the clipping frame Cf(N−1).

Likewise, in the sixth embodiment, the stabilized image Si(N+1) for the frame image Fi(N+1) shown in FIG. 19 can be generated by adopting the clipping frame Cf(N) instead of the clipping frame Cf(N−1).

### <11-3. Third Modification>

In a third modification, an image processing device 2D is provided inside an image sensor 4D.

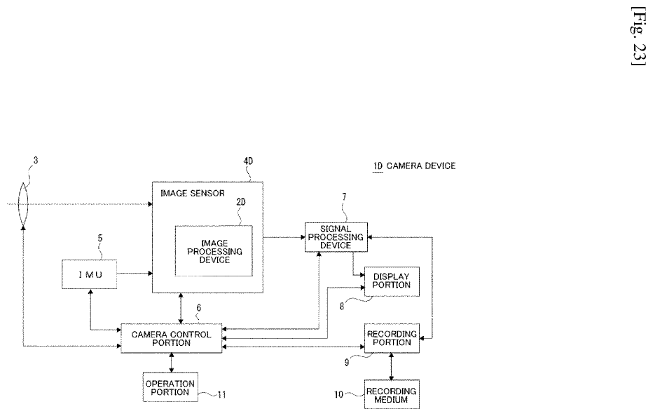

Specifically, as shown in FIG. 23, the camera device 1D includes an optical lens system 3, an image sensor 4D, an IMU 5, a camera control portion 6, a signal processing portion 7, a display portion 8, a recording portion 9, a recording medium 10, and an operation portion 11.

The image sensor 4D includes the image processing device 2D in addition to a light receiving portion and the like.

Also, an interface for the IMU data output from the IMU 5 is mounted on the image sensor 4D. The image processing device 2D can take in IMU data from the IMU 5 via this interface.

This allows the image processing device 2D to perform the various types of processing described above while positioned within the image sensor 4D.

### 12. Others

In each of the above examples, the calculation result of the clipping position is within the area output from the image sensor 4, but other examples are also conceivable.

For example, the image sensor 4 may include a pixel array portion for an 8K image. That is, the image sensor 4 has a pixel array portion with about 4k pixels in the vertical direction and about 8k pixels in the horizontal direction.

That is, an 8K image is output from the pixel array portion. The image sensor 4 clips a predetermined area from the 8K image output from the pixel array portion and supplies it to the outside of the image sensor 4 as the frame image Fi described above. For example, the frame image Fi output from the image sensor 4 is a 4K image in which the number of vertical pixels is 2k and the number of horizontal pixels is 4k.

The stabilization process by the stabilization process portion 25 is a process of calculating the position of the clipping frame Cf in the 4K image as the frame image Fi. However, as described above, a part of the calculated clipping frame Cf may be located outside the frame image Fi.

In each of the examples described above, a process of resetting the clipping frame Cf within the area of the frame image Fi is performed. However, this example performs a process of changing the area of the frame image Fi output from the image sensor 4.

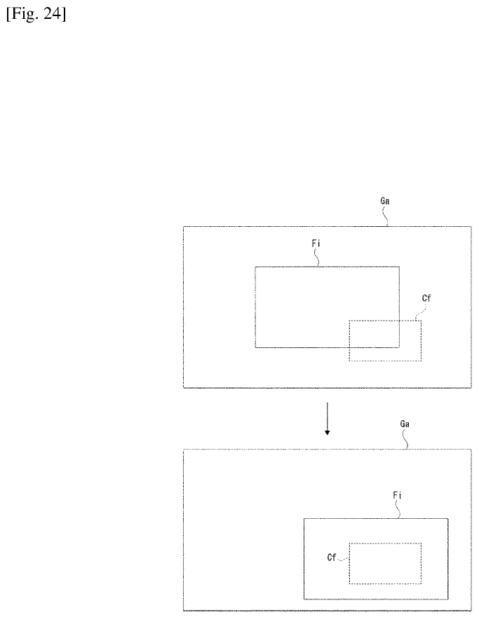

This is specifically illustrated in FIG. 24. An 8K image output from the pixel array portion is referred to as an 8K image Ga. An image output from the image sensor 4 and clipped from the 8K image Ga is referred to as a frame image Fi.

FIG. 24 shows an example of a frame image Fi clipped from the 8K image Ga and a clipping frame Cf that extends off the frame image Fi.

In this case, the image sensor 4 changes the clipping position in the 8K image Ga, and sets the area of the frame image Fi so as to include the clipping frame Cf (lower part in the figure).

As a result, it is possible to provide the subsequent stage (or the user) with an appropriate image in which the stabilization function is effective.

When an instruction to change the clipping position is transmitted to the image sensor 4 in this manner, the data amount of the information sent from the image processing device 2 from the image sensor 4 is increased. Consequently, the communication may fail to be completed by the original timing intended for each frame.

In this case, the communication start timing is moved forward so that the communication is completed by the original timing.

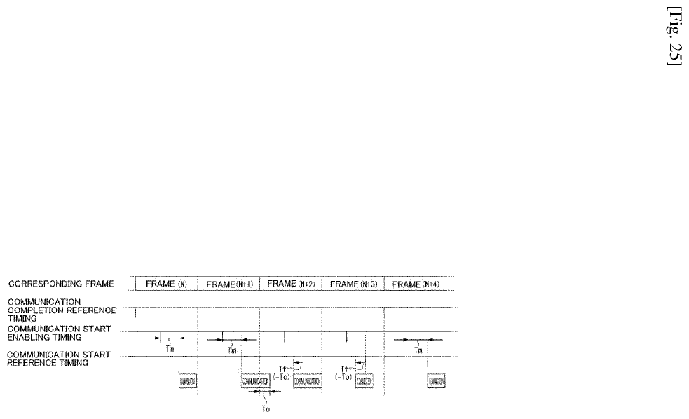

This is specifically illustrated in FIG. 25.

First, the reference timing for communication completion is defined by a vertical synchronization signal Vsync1 or a signal obtained by adding a delay thereto (“communication completion reference timing” in the figure).

Also, the timing at which data to be communicated is ready, which is the timing at which communication can be started, is also defined by a signal obtained by adding a delay to Vsync1 (“communication start enabling timing” in the figure).

The reference timing for starting actual communication is defined by a signal obtained by adding a delay to the signal defining the communication enabling timing (“communication start reference timing” in the figure).

Here, the time difference between the communication start enabling timing and the communication start reference timing can be regarded as the margin time Tm as in the second embodiment.

In the example shown in FIG. 25, the communication for the frame (N) is started at the communication start reference timing and completed by the communication completion reference timing.

Next, the communication for the frame (N+1) includes an instruction to change the clipping position to the image sensor 4 described above, and the amount of communication is greater. Consequently, the communication completion timing is behind the communication completion reference timing. The differential time between the communication completion reference timing and the timing at which the communication is completed can then be regarded as the overrun time To about communication, as in the second embodiment.

As such, for the communication for the next frame (N+2), an advance time Tf equal to the overrun time To is set to consume the margin time Tm. That is, the communication is started earlier than the communication start reference timing by the advance time Tf. As a result, the communication completion timing for the communication about the frame (N+2) is completed by the communication completion reference timing.

When there is a time difference between the communication completion timing and the communication completion reference timing as in the frame (N+3), the margin time Tm may be restored by returning the communication start timing to the reference timing.

### 13. Summary

As described in the above examples, the image processing device 2 (2A, 2B, 2C, 2D) of the present technology includes a stabilization process portion 25 (25A, 25B) configured to perform a stabilization process for electronic image stabilization by clipping a part of a frame image Fi as a captured image on the basis of a clipping position, and an image output portion 26 configured to output, as an output image Oi, an image to which the stabilization process is applied (stabilized image Si).

When a processing overrun occurs in which the processing time of the stabilization process for a processing target frame image Fi is longer than predetermined, the stabilization process portion 25 adopts, as the clipping position for the processing target frame image Fi, the clipping position for a previous frame image Fi prior thereto.

Also, the image output portion 26 outputs, as the output image Oi, a partial image that is clipped from the processing target frame image Fi on the basis of the clipping position for the previous frame image Fi.

As a result, an image clipped from the frame image Fi is output as the output image Oi even when the stabilization process is not completed in time.

That is, this prevents a situation in which the output of the output image Oi is interrupted or stopped, and a situation in which a meaningless image that is irrelevant to the captured image (such as mute images of all white or all black) is output, when the stabilization process is not completed in time. Also, the output image Oi output at this time is an image clipped from the latest frame image Fi to be subjected to the stabilization process that was not completed in time, although the clipping position remains the same. As such, an image normally clipped from the previous frame image Fi is not continuously displayed thereafter, and an appropriate image can be displayed as much as possible even in an abnormal state.

As described with reference to FIG. 2 and the like, in the image processing device 2 (2A, 2B, 2C, 2D) may include an orientation information input portion 23 to which orientation information (IMU data including partial IMU data D) corresponding to the processing target frame image Fi is input, and the stabilization process portion 25 (25A, 25B) may calculate the clipping position using the orientation information in the stabilization process.

As a result, in the camera device 1 (1D) in which the IMU 5 capable of detecting the orientation and the image processing device 2 are installed, for example, it is possible to continue displaying an appropriate image as much as possible when a processing overrun of a stabilization process occurs due to the shake of the camera device 1 caused by the camera shake of the photographer.

As described with reference to FIGS. 2, 4, and the like, a plurality of pieces of orientation information corresponding to one frame image Fi may be input to the orientation information input portion 23 of the image processing device 2 (2A, 2B, 2C, 2D), and the stabilization process portion 25 (25A, 25B) may be configured to perform divisional stabilization processes E (F) obtained by dividing the stabilization process, using partial orientation information (partial IMU data D, Da) obtained by dividing the plurality of pieces of orientation information corresponding to the one frame image Fi into a plurality of groups by time.

As a result, for example, a part of the stabilization process can be performed in advance before all the pieces of orientation information input corresponding to one frame image Fi are available.

Consequently, it is possible to shorten the time from the exposure of the frame image Fi to the output of the output image Oi when the stabilization process is performed.

As described in the first embodiment with reference to FIG. 4 and the like, the stabilization process portion 25 (25A, 25B) in the image processing device 2 (2A, 2B, 2C, 2D) may be configured to, when a processing overrun occurs, skip the stabilization process for the next frame image Fi following the processing target frame image Fi and adopt the clipping position for the previous frame image Fi as the clipping position for the next frame image Fi. Also, the image output portion 26 may be configured to output, as the output image Oi, a part of the next frame image Fi that is clipped on the basis of the clipping position for the previous frame image Fi.

For example, when the stabilization process for the processing target frame image Fi(N) is performed for a longer period than predetermined, the execution period of the stabilization process for the next frame image Fi(N+1) may be encroached, causing it to be completed in time. In this case, there is a possibility that the execution time of the stabilization process for the next frame image Fi(N+2) may also be encroached.

In this case, by skipping and not performing the stabilization process for the next frame image Fi(N+1), it is possible to limit the influence when the stabilization process for the processing target frame image Fi(N) is not completed in time.

As described in the fourth embodiment with reference to FIGS. 14, 15, and the like, the stabilization process portion 25 in the image processing device 2 (2D) may be configured to, when a processing overrun occurs, shift to a thinning stabilization process that is performed by thinning out a part of a plurality of divisional stabilization processes E to be performed for one frame image Fi.

When a change in orientation is substantial and the clipping position is outside the frame of the frame image Fi, a processing overrun is likely to occur. In this case, a part of the divisional stabilization process E is skipped to reduce the amount of computation for the entire stabilization process.

As a result, the frequency of occurrence of a processing overrun can be reduced, increasing the possibility of outputting an appropriate image in which electronic image stabilization is effective.

As described in the sixth embodiment with reference to FIGS. 19, 20, and the like, the stabilization process portion 25 in the image processing device 2 (2D) may be configured to, when a processing overrun occurs, shift to a simple stabilization process that performs the divisional stabilization processes without using part of the partial orientation information (partial IMU data D).

When a change in orientation is substantial and the clipping position is outside the frame of the frame image Fi, a processing overrun is likely to occur. In this case, the orientation information used for the stabilization process is reduced to reduce the amount of computation for the entire stabilization process.

As a result, the frequency of occurrence of a processing overrun can be reduced, increasing the possibility of outputting an appropriate image in which electronic image stabilization is effective.

As described in the fifth embodiment with reference to FIGS. 16 to 18, the orientation information (IMU data) may be input to the orientation information input portion 23 of the image processing device 2B (2D) at a first sampling rate H1 in the divisional stabilization process E performed using all the partial orientation information (partial IMU data D), and the orientation information may be input to the orientation information input portion 23 at a second sampling rate H2 that is lower than the first sampling rate H1 in the simple stabilization process.

By lowering the sampling rate of the orientation information when a processing overrun occurs, it is possible to reduce the amount of computation for the entire stabilization process and reduce the frequency of occurrence of a processing overrun. Consequently, the possibility of outputting an appropriate image with effective electronic image stabilization can be increased.

As described in the second embodiment with reference to FIGS. 6, 7, and the like, the image output portion 26 of the image processing device 2A (2C, 2D) may include a buffer memory 26a configured to store, as a stabilized image Si, an image to which the stabilization process is applied. A timing adjustment portion 30 may be provided that is configured to delay a timing at which the stabilized image Si is input to the image output portion 26 from the stabilization process portion 25A by, of a margin time Tm between when the stabilized image Si is input to the image output portion 26 and when the output image Oi is output, a portion of the margin time Tm that is consumed by the processing time being longer than predetermined (that is, by the overrun time To).

By providing the buffer memory 26a in which the stabilized image Si is temporarily stored, a margin time Tm is ensured that does not affect the output timing of the output image Oi even when the execution time of the stabilization process is slightly advanced or delayed.

Also, the timing adjustment portion 30, which adjusts the timing at which the stabilized image Si is input to the image output portion 26, is provided. Thus, when the execution time of the stabilization process is prolonged, this can be offset by consuming the margin time Tm.

This increases the possibility of outputting an appropriate image in which electronic image stabilization is effective, even when a processing overrun occurs.

As described in the second embodiment and the like with reference to FIG. 7, the timing adjustment portion 30 in the image processing device 2A (2C, 2D) may be configured to, when the processing time for the stabilization process returns to a length that does not consume the margin time Tm, return the timing at which the stabilized image Si is input to the image output portion 26 from the stabilization process portion 25A to a state before being delayed.

When the execution time of the stabilization process returns to the original time, the timing adjustment portion 30 advances the timing, thereby restoring the margin time Tm. This increases the possibility of outputting an appropriate image in which electronic image stabilization is effective when a next processing overrun occurs.

As described in the third embodiment with reference to FIGS. 9 to 13, in the image processing device 2A (2C, 2D), when the margin time Tm is insufficient, the stabilization process portion 25A may skip the stabilization process for the next frame image Fi following the processing target frame image Fi and adopt the clipping position for the previous frame image Fi as the clipping position for the next frame image Fi.

Also, the image output portion 26 may output, as the output image Oi, a part of the next frame image Fi that is clipped on the basis of the clipping position for the previous frame image Fi.

That is, when the execution time of the stabilization process becomes too long to be offset with the margin time Tm, the stabilization process for the next frame image Fi is skipped, and the image clipped at the clipping position previously calculated is output as an output image Oi.

This can reduce and limit the influence of a significant delay of the stabilization process for the processing target frame image Fi, while increasing the possibility of outputting an appropriate image in which electronic image stabilization is effective when a processing overrun occurs.

As described in the first modification with reference to FIG. 21, a storage portion (memory 31) may be provided that is configured to temporarily store the stabilized image Si output from the stabilization process portion 25A of the image processing device 2C (2D) and output the stabilized image Si to the image output portion 26.

As a result, the margin time Tm can be increased, increasing the possibility of outputting an appropriate image in which electronic image stabilization is effective when a processing overrun occurs.

As described with reference to FIG. 4 and the like, in the image processing device 2 (2A, 2B, 2C, and 2D), the previous frame image Fi may be the last frame image Fi with which the processing time of the stabilization process is less than or equal to a predetermined time.

That is, the image can be clipped using the latest (last) clipping position with which the calculation process is completed in time, among many clipping positions for the previous frame images Fi. This increases the possibility of outputting, as an output image Oi, an appropriate image that bears comparison with an image in which electronic image stabilization is effective.

Furthermore, an image processing method as embodiment is an image processing method including executing on a processor the processes of: when a processing time of a stabilization process for electronic image stabilization that clips a part of a frame image Fi as a captured image on the basis of a clipping position is longer than predetermined, adopting, as the clipping position for a frame image Fi to be subjected to the stabilization process, the clipping position for a previous frame image Fi prior thereto; and outputting, as an output image, a partial image that is clipped from the frame image Fi to be subjected to the stabilization process on the basis of the clipping position for the previous frame image Fi.

Furthermore, a storage medium as an embodiment is a computer-readable storage medium storing a program causing a processor to execute the functions of: when a processing time of a stabilization process for electronic image stabilization that clips a part of a frame image Fi as a captured image on the basis of a clipping position is longer than predetermined, adopting, as the clipping position for a frame image Fi to be subjected to the stabilization process, the clipping position for a previous frame image Fi prior thereto; and outputting, as an output image, a partial image that is clipped from the frame image Fi to be subjected to the stabilization process on the basis of the clipping position for the previous frame image Fi.

With these signal processing method and storage medium, it is possible to obtain the same actions and effects as those of the image processing device described above.

It should be noted that the effects described in this specification are merely examples and are not limiting, and other effects may also occur.

Furthermore, the examples described above may be combined in any way, and even when various combinations are used, it is possible to obtain the various advantageous effects described above.

### 14. Present Technology

The present technology can also adopt the following configurations.
(1) An image processing system including
   circuitry configured to
   determine whether a processing overrun has occurred following generation of a first clipped image based on a first frame of image data captured by an image sensor;
   acquire a second frame of image data captured by the image sensor after the first frame of image data has been captured;
   generate a second clipped image based on the second frame of image data and second movement data corresponding to movement of the image sensor while capturing the second frame of image data in a case it is determined that the processing overrun has not occurred;
   generate the second clipped image based on the second frame of image data and first movement data corresponding to movement of the image sensor while capturing a previous frame of image data in a case it is determined that the processing overrun has occurred; and
   outputting the second clipped image.
(2)

The image processing system of (1), wherein the circuitry is configured to:
acquire the first frame of image data;
acquire the first movement data;
generate the first clipped image based on the first frame of image data and the first movement data; and
output the first clipped image.
(3)

The image processing system of any of (1) to (2), wherein the circuitry is configured to:
acquire the second movement data corresponding to movement data of the image sensor while capturing the second frame of image data; and
generate the second clipped image based on the second frame of image data and the first movement data in the case it is determined that the processing overrun has occurred.
(4)

The image processing system of any of (1) to (3), wherein the circuitry is configured to:
generate, in the case it is determined that the processing overrun has occurred, the second clipped image based on the second frame of image data and the first movement data, the first movement data corresponding to movement of the image sensor while capturing the first frame of image data in a case it is determined that the processing overrun has occurred.
(5)

The image processing system of any of (1) to (4), wherein the circuitry is configured to:
output the second clipped image at a first timing in the case it is determined that the processing overrun has not occurred; and
output the second clipped image at a second timing, which is delayed from the first timing, in the case it is determined that the processing overrun has occurred.
(6)

The image processing system of (5), wherein
the second timing is variable according a capacity of a buffer memory of the image processing system that is configured to store the second clipped image.
(7)

The image processing system of any of (1) to (6), wherein the circuitry is configured to:
acquire a first plurality of pieces of partial movement data corresponding to the first frame of image data; and
generate the first clipped image based on the first frame of image data and the plurality of pieces of partial movement data.
(8)

The image processing system of claim 7, wherein the circuitry is configured to:
perform control to reduce a number of pieces of the partial movement data used to generate a clipped image for a frame of image data captured in the case it is determined that the processing overrun has occurred.
(9)

The image processing system of any of (1) to (8), wherein the circuitry is configured to:
generate the second clipped image based on the second frame of image data and a subset of a plurality of pieces of partial movement data corresponding to frames of image data captured prior to capturing the second frame of image data.
(10)

The image processing system of any of (7) to (9), wherein the circuitry is configured to:
perform control to reduce a size of each piece of the partial movement data used to generate a clipped image for a frame of image data captured in the case it is determined that the processing overrun has occurred.
(11)

The image processing system of any of (1) to (10), wherein the circuitry is configured to:
perform control to reduce a size of each piece of partial movement data acquired for each frame of image data in the case it is determined that the processing overrun has occurred.
(12)

The image processing system of (11), wherein the circuitry is configured to:
generate the second clipped image based on the second frame of image data and a plurality of reduced size pieces of partial movement data corresponding to movement of the image sensor while the second image is captured by the image sensor.
(13)

The image processing system of any of (1) to (12), further comprising:
a sensor configured to detect movement of the image processing system.
(14)

The image processing system of (13), wherein
the movement detected by the sensor includes acceleration information and angular velocity information corresponding to the movement and orientation of the image processing system.
(15)

The image processing system of any of (1) to (14), wherein
the circuitry is configured to generate the first movement data and the second movement data based on an output of the sensor.
(16)

The image processing system of any of (1) to (15), wherein
the circuitry is a microprocessor.
(17)

The image processing system of any of (1) to (16), further comprising:
an image sensor configured to capture the first frame of image data and the second frame of image data and output the first frame of image data and the second frame of image data to the circuitry; and
a display configured to display the first clipped image and the second clipped image, wherein
the circuitry is a microprocessor.
(18)

The image processing system of any of (1) to (17), wherein
the circuitry is configured to determine whether a processing overrun has occurred in a case that a time it takes to generate the first clipped image exceeds a predetermined time threshold.
(19)

An image processing method including:
generating a first clipped image based on a first frame of image data captured by an image sensor and first movement data corresponding to movement of the image sensor while the capturing the first frame of image data;
outputting the first clipped image;
acquiring a second frame of image data and movement data corresponding to movement of the image sensor whole capturing the second frame of image data;
determining that a processing overrun has occurred as a result of generating the first clipped image;
generating a second clipped image based on movement data corresponding to a previously acquired frame image data in response to determining that the processing overrun has occurred; and
outputting the second clipped image.
(20)

One or more non-transitory computer readable media including computer program instructions, which when executed by circuitry, cause the circuitry to:
generate a first clipped image based on a first frame of image data captured by an image sensor and first movement data corresponding to movement of the image sensor while the capturing the first frame of image data;
output the first clipped image;
acquire a second frame of image data and movement data corresponding to movement of the image sensor whole capturing the second frame of image data;
determine that a processing overrun has occurred as a result of generating the first clipped image;
generate a second clipped image based on movement data corresponding to a previously acquired frame image data in response to determining that the processing overrun has occurred; and
output the second clipped image.

### REFERENCE SIGNS LIST

2, 2A, 2B, 2C, 2D Image processing device
23 Orientation information input portion
25, 25A, 25B Stabilization process portion
26 Image output portion
26a Buffer memory
30 Timing adjustment portion
31 Memory (storage portion)
Fi Frame image
D, Da Partial IMU data (partial orientation information)
Si Stabilized image
Oi Output image
E, F Divisional stabilization process
Tm Margin time
H1 First sampling rate
H2 Second sampling rate

1. An image processing system comprising:
circuitry configured to
determine whether a processing overrun has occurred following generation of a first clipped image based on a first frame of image data captured by an image sensor;
acquire a second frame of image data captured by the image sensor after the first frame of image data has been captured;
generate a second clipped image based on the second frame of image data and second movement data corresponding to movement of the image sensor while capturing the second frame of image data in a case it is determined that the processing overrun has not occurred;
generate the second clipped image based on the second frame of image data and first movement data corresponding to movement of the image sensor while capturing a previous frame of image data in a case it is determined that the processing overrun has occurred; and
output the second clipped image.

2. The image processing system of claim 1, wherein the circuitry is configured to:
acquire the first frame of image data;
acquire the first movement data;
generate the first clipped image based on the first frame of image data and the first movement data; and
output the first clipped image.

3. The image processing system of claim 1, wherein the circuitry is configured to:
acquire the second movement data corresponding to movement data of the image sensor while capturing the second frame of image data; and
generate the second clipped image based on the second frame of image data and the first movement data in the case it is determined that the processing overrun has occurred.

4. The image processing system of claim 1, wherein the circuitry is configured to:
generate, in the case it is determined that the processing overrun has occurred, the second clipped image based on the second frame of image data and the first movement data, the first movement data corresponding to movement of the image sensor while capturing the first frame of image data in a case it is determined that the processing overrun has occurred.

5. The image processing system of claim 1, wherein the circuitry is configured to:
output the second clipped image at a first timing in the case it is determined that the processing overrun has not occurred; and
output the second clipped image at a second timing, which is delayed from the first timing, in the case it is determined that the processing overrun has occurred.

6. The image processing system of claim 5, wherein
the second timing is variable according a capacity of a buffer memory of the image processing system that is configured to store the second clipped image.

7. The image processing system of claim 1, wherein the circuitry is configured to:
acquire a first plurality of pieces of partial movement data corresponding to the first frame of image data; and
generate the first clipped image based on the first frame of image data and the plurality of pieces of partial movement data.

8. The image processing system of claim 7, wherein the circuitry is configured to:
perform control to reduce a number of pieces of the partial movement data used to generate a clipped image for a frame of image data captured in the case it is determined that the processing overrun has occurred.

9. The image processing system of claim 1, wherein the circuitry is configured to:
generate the second clipped image based on the second frame of image data and a subset of a plurality of pieces of partial movement data corresponding to frames of image data captured prior to capturing the second frame of image data.

10. The image processing system of claim 7, wherein the circuitry is configured to:
perform control to reduce a size of each piece of the partial movement data used to generate a clipped image for a frame of image data captured in the case it is determined that the processing overrun has occurred.

11. The image processing system of claim 1, wherein the circuitry is configured to:
perform control to reduce a size of each piece of partial movement data acquired for each frame of image data in the case it is determined that the processing overrun has occurred.

12. The image processing system of claim 11, wherein the circuitry is configured to:
generate the second clipped image based on the second frame of image data and a plurality of reduced size pieces of partial movement data corresponding to movement of the image sensor while the second image is captured by the image sensor.

13. The image processing system of claim 1, further comprising:
a sensor configured to detect movement of the image processing system.

14. The image processing system of claim 13, wherein
the movement detected by the sensor includes acceleration information and angular velocity information corresponding to the movement and orientation of the image processing system.

15. The image processing system of claim 13, wherein
the circuitry is configured to generate the first movement data and the second movement data based on an output of the sensor.

16. The image processing system of claim 1, wherein
the circuitry is a microprocessor.

17. The image processing system of claim 1, further comprising:
an image sensor configured to capture the first frame of image data and the second frame of image data and output the first frame of image data and the second frame of image data to the circuitry; and
a display configured to display the first clipped image and the second clipped image, wherein
the circuitry is a microprocessor.

18. The image processing system of claim 1, wherein
the circuitry is configured to determine whether a processing overrun has occurred in a case that a time it takes to generate the first clipped image exceeds a predetermined time threshold.

19. An image processing method comprising:
generating a first clipped image based on a first frame of image data captured by an image sensor and first movement data corresponding to movement of the image sensor while the capturing the first frame of image data;
outputting the first clipped image;
acquiring a second frame of image data and movement data corresponding to movement of the image sensor whole capturing the second frame of image data;
determining that a processing overrun has occurred as a result of generating the first clipped image;
generating a second clipped image based on movement data corresponding to a previously acquired frame image data in response to determining that the processing overrun has occurred; and
outputting the second clipped image.

20. One or more non-transitory computer readable media including computer program instructions, which when executed by circuitry, cause the circuitry to:
generate a first clipped image based on a first frame of image data captured by an image sensor and first movement data corresponding to movement of the image sensor while the capturing the first frame of image data;
output the first clipped image;
acquire a second frame of image data and movement data corresponding to movement of the image sensor whole capturing the second frame of image data;
determine that a processing overrun has occurred as a result of generating the first clipped image;
generate a second clipped image based on movement data corresponding to a previously acquired frame image data in response to determining that the processing overrun has occurred; and
output the second clipped image.
